(19) United States
(12) Patent Application Publication
(10) Pub. No.: US 2025/0055539 A1
(43) Pub. Date: Feb. 13, 2025

(54) METHOD AND DEVICE FOR RECEIVING AND TRANSMITTING INFORMATION

(71) Applicant: SAMSUNG ELECTRONICS CO., LTD., Suwon-si (KR)

(72) Inventors: Zhe CHEN, Beijing (CN); Feifei SUN, Beijing (CN)

(21) Appl. No.: 18/798,675

(22) Filed: Aug. 8, 2024

(30) Foreign Application Priority Data
Aug. 9, 2023 (CN) 202311002208.2
Apr. 3, 2024 (CN) 202410405161.2
May 17, 2024 (CN) 202410619911.6

(51) Int. Cl. H04B 7/06; H04B 17/318; H04L 1/1607

(52) U.S. Cl. CPC H04B 7/0626; H04B 17/328; H04L 1/1642

(57) ABSTRACT

The disclosure relates to a 5G or 6G communication system for supporting a higher data transmission rate. The present disclosure provides a method performed by a UE in a wireless communication system, the method including: receiving a channel state information (CSI) report configuration, wherein the CSI report configuration includes information of a first resource; and determining and/or reporting a CSI parameter based on the first resource, wherein: when the first resource is periodic or semi-persistent, the first resource corresponds to a plurality of measurement occasion groups, the CSI parameter is determined based on each of the plurality of measurement occasion groups; or when the first resource is aperiodic, the first resource includes a plurality of resource groups in a plurality of time units, the CSI parameter is determined based on each of the plurality of resource groups.

### CROSS-REFERENCE TO RELATED APPLICATIONS

This application is based on and claims priority under 35 U.S.C. § 119 to Chinese Patent Application No. 202311002208.2 filed Aug. 9, 2023, Chinese Patent Application No 202410405161.2, filed Apr. 3, 2024, and Chinese Patent Application No 202410619911.6, filed May 17, 2024, all filed in the Chinese Intellectual Property Office, the disclosures of which are incorporated by reference herein in their entirety.

### BACKGROUND

### 1. Field

The present disclosure relates to a field of wireless communication and, more particularly, to a method and device for receiving and transmitting information.

### 2. Description of Related Art

In order to meet the increasing demand for wireless data communication services since the deployment of 4^{th} generation (4G) communication systems, efforts have been made to develop improved 5G or pre-5G communication systems. Therefore, 5G or pre-5G communication systems are also called “Beyond 4G networks” or “Post-LTE systems.”

In order to achieve a higher data rate, 5G communication systems are implemented in higher frequency (millimeter, mmWave) bands, e.g., 60 GHz bands. In order to reduce propagation loss of radio waves and increase a transmission distance, technologies such as beamforming, massive multiple-input multiple-output (MIMO), full-dimensional MIMO (FD-MIMO), array antenna, analog beamforming and large-scale antenna are discussed in 5G communication systems.

In addition, in 5G communication systems, developments of system network improvement are underway based on advanced small cell, cloud radio access network (RAN), ultra-dense network, device-to-device (D2D) communication, wireless backhaul, mobile network, cooperative communication, coordinated multi-points (COMP), reception-end interference cancellation, etc.

In 5G systems, hybrid FSK and QAM modulation (FQAM) and sliding window superposition coding (SWSC) as advanced coding modulation (ACM), and filter bank multicarrier (FBMC), non-orthogonal multiple access (NOMA) and sparse code multiple access (SCMA) as advanced access technologies have been developed.

A transmission from a base station to a user equipment (UE) is called downlink, and a transmission from a UE to a base station is called uplink.

5^{th} generation (5G) mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mm Wave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

The above information is presented as background information only to assist with an understanding of the disclosure. No determination has been made, and no assertion is made, as to whether any of the above might be applicable as prior art with regard to the disclosure.

### SUMMARY

In order to enhance the scheduling efficiency of 5G wireless communication systems, a base station needs to obtain channel state information (CSI) for scheduling according to the CSI fed back by a terminal device. However, it is still problematic to further enhance the performance of CSI report.

The technical objects to be achieved by various embodiments of the disclosure are not limited to the technical objects mentioned above, and other technical objects not mentioned may be considered by those skilled in the art from various embodiments of the disclosure to be described below.

An aspect of the disclosure provides a method performed by a UE in a wireless communication system, the method including: receiving a channel state information (CSI) report configuration, wherein the CSI report configuration includes information of a first resource; and determining and/or reporting a CSI parameter based on the first resource, wherein: when the first resource is periodic or semi-persistent, the first resource corresponds to a plurality of measurement occasion groups, the CSI parameter being determined based on each of the plurality of measurement occasion groups; or when the first resource is aperiodic, the first resource includes a plurality of resource groups in a plurality of time units, the CSI parameter being determined based on each of the plurality of resource groups.

In an example, each measurement occasion group includes all measurement occasions of one or more resources included in the first resource within a measurement window corresponding to each measurement occasion group.

In an example, a measurement window corresponding to a last measurement occasion group of the plurality of measurement occasion groups is determined based on at least one of: an offset between a last time unit of the configured measurement window and a CSI reference resource associated with the CSI parameter; an offset between a last time unit of the configured measurement window and a time unit where the CSI parameter is reported; a last measurement window of one or more measurement windows determined based on periodicity of the first resource and/or a subframe number (SFN) that is no later than a CSI reference resource associated with the CSI parameter; a last measurement window of one or more measurement windows determined based on periodicity of the first resource and/or a subframe number (SFN) that is no later than a time unit before a time unit where the CSI parameter is reported.

In an example, the last measurement window of the one or more measurement windows that is no later than the CSI reference resource associated with the CSI parameter includes at least one of: all measurement occasions in the last measurement window being no later than the CSI reference resource; at least one of measurement occasions corresponding to each of the one or more resources in the last measurement window being no later than the CSI reference resource; the last time unit in the last measurement window being no later than the CSI reference resource.

In an example, a length of the measurement window is determined based on the periodicity of the first resource; and/or an interval between the plurality of measurement windows corresponding to the plurality of measurement occasion groups is determined based on the periodicity of the first resource.

In an example, the plurality of time units is respectively determined based on a reference time unit and one or more first offsets corresponding to one or more resources included in the first resource, or each of the plurality of resource groups corresponds to one or more time units related to a reference time unit, wherein the reference time unit is determined based on a channel state information reference signal (CSI-RS) triggering offset corresponding to the first resource.

In an example, the one or more time units are determined based on one of: a spacing of two adjacent resource groups from the plurality of resource groups, a second offset configured for each resource in each of the plurality of resource groups.

In an example, relative positions of the resource in each resource group are determined based on at least one of: one or more third offsets corresponding to each resource group, an order of all the resource corresponding to each resource group.

In an example, the plurality of resource groups is determined based on Radio resource control (RRC) signaling and/or an order of one or more resources included in the first resource.

In an example, the earliest of the first resource is in the same time unit as the reference time unit, or the earliest of the one or more time units corresponding to the earliest of the plurality of resource groups is in the same time unit as the reference time unit.

In an example, the CSI parameter includes the CSI parameter corresponding to each of the plurality of measurement occasion groups, or the CSI parameter corresponding to each of the plurality of resource groups.

In an example, the CSI parameter corresponding to each measurement occasion group includes a resource indicator and/or a first number of values of Layer 1-reference signal received power (L1-RSRP) corresponding to each measurement occasion group; or the CSI parameter corresponding to each resource group includes a resource indicator and/or a first number of values of L1-RSRP corresponding to each resource group; the first number is configured via higher layer signaling.

In an example, the plurality of measurement occasion groups shares the same resource indicator or the plurality of measurement occasion groups each has a respective resource indicator.

In an example, the resource indicator corresponding to each measurement occasion group or each resource group includes at least one of: the first number of a first resource indicator to indicate a resource that is reported; a number of a second resource indicator to indicate a resource that is not reported, the number being the number of a plurality of resources included in the first resource minus the first number.

In an example, the CSI parameter corresponding to each resource group is determined based on the number of the resource in the corresponding resource group.

In an example, the CSI report configuration corresponds to differential L1-RSRP based reporting; and the CSI parameter includes a group indicator representing the measurement occasion group or resource group where a largest measured value of L1-RSRP is located and/or the resource indicator corresponding to the group indicator, or the CSI parameter includes a resource indicator corresponding to each measurement occasion group representing the resource corresponding to the largest measured value of L1-RSRP.

In an example, an order of the CSI parameter is determined based on an order of the plurality of measurement occasion groups or an order of the plurality of resource groups.

In an example, the CSI parameter includes a predicted CSI parameter for each of a second number of time intervals, wherein an earliest time interval of the second number of time intervals is determined based on at least one of: the time unit where the CSI parameter is reported; the CSI reference resource associated with the CSI report; the last measurement window of the one or more measurement windows determined based on the periodicity of the first resource and/or the subframe number (SFN) that is later than the CSI reference resource associated with the CSI parameter; the last measurement window of the one or more measurement windows determined based on the periodicity of the first resource and/or the subframe number (SFN) that is not earlier than the time unit where the CSI parameter is reported.

In an example, the spacing between two adjacent time interval of the second number of time intervals or a length of each of the second number of time intervals is determined based on at least one of: the periodicity of the first resource; the spacing of two adjacent resource groups from the plurality of resource groups.

In an example, the periodicity of the first resource is determined based on at least one of an uplink subcarrier spacing and a downlink subcarrier spacing.

In an example, the predicted CSI parameter includes a beam indicator corresponding to each time interval and/or a third number of values of L1-RSRP, wherein the third number is configured via higher layer signaling.

In an example, the second number of time intervals share the same beam indicator, or the second number of time intervals each have a respective beam indicator.

In an example, the beam indicator corresponding to each time interval includes at least one of: a third number of first beam indicators to indicate reported beams; a number of a second resource indicator to indicate a resource that is not reported, the number being the number of a plurality of resources included in the first resource minus the third number.

In an example, the CSI report configuration corresponds to differential L1-RSRP based CSI report; and the predicted CSI parameter includes: a time interval indicator representing a time interval where the largest value of L1-RSRP is located and/or a beam indicator corresponding to the time interval indicator; or the predicted CSI parameter includes a beam indicator corresponding to each time interval representing a beam corresponding to the largest value of L1-RSRP.

In an example, the order of the CSI parameter is determined based on an order of the second number of time intervals.

Another aspect of the disclosure provides a method performed by a base station in a wireless communication system, the method including: transmitting a channel state information (CSI) report configuration, wherein the CSI report configuration includes information of a first resource; and receiving a CSI parameter determined based on the first resource, wherein: when the first resource is periodic or semi-persistent, the first resource corresponds to a plurality of measurement occasion groups, the CSI parameter being determined based on each of the plurality of measurement occasion groups; or when the first resource is aperiodic resource, the first resource includes a plurality of resource groups in a plurality of time units, the CSI parameter being determined based on each of the plurality of resource groups.

Another aspect of the disclosure provides a user equipment including: a transceiver; and a controller coupled with the transceiver and configured to perform the method described above, which may be performed by the user equipment.

Another aspect of the present disclosure provides a base station including: a transceiver; and a controller coupled with the transceiver and configured to perform the above-described method that may be performed by the controller.

The above-described various embodiments of the disclosure are merely some of the preferred embodiments of the disclosure, and various embodiments reflecting the technical features of the disclosure may be derived and understood by those skilled in the art based on the following detailed description of the disclosure.

The present disclosure provides a method to improve CSI performance, which in turn improves scheduling efficiency of the communication system.

The effects that can be achieved through the disclosure are not limited to the effects mentioned in the various embodiments, and other effects not mentioned will be clearly understood by those skilled in the art from the description below.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF DRAWINGS

The above and other aspects, features, and advantages of the present disclosure will be more apparent from the following detailed description when taken in conjunction with the accompanying drawings.

FIG. 1 illustrates an overall structure of wireless communication network according to various embodiments of the present disclosure;

FIGS. 2A and 2B illustrate a transmission path 2 and a reception path, respectively, in a wireless communication network according to various embodiments of the present disclosure;

FIGS. 3A and 3B illustrate structures of a UE and a base station, respectively, in a wireless communication network according to various embodiments of the present disclosure;

FIG. 4 illustrates a method performed by a UE according to various embodiments of the present disclosure;

FIG. 5 illustrates a method performed by a base station according to various embodiments of the present disclosure;

FIG. 6 illustrates a structure of a US according to various embodiments of the present disclosure; and

FIG. 7 illustrates a structure of a base station according to various embodiments of the present disclosure.

### DETAILED DESCRIPTION

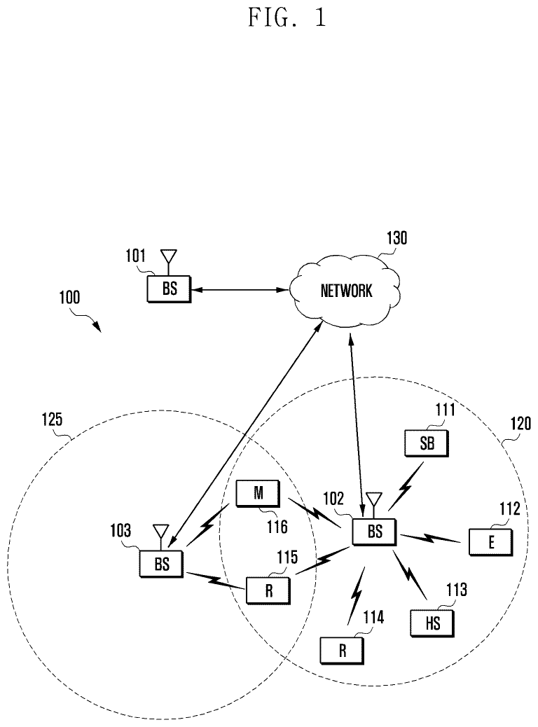

FIGS. 1 through 7, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

Hereinafter, embodiments of the disclosure will be described in detail with reference to the accompanying drawings. It should be noted that in the drawings, the same or similar elements are preferably denoted by the same or similar reference numerals. In addition, detailed descriptions of known functions or configurations that may make the subject matter of the disclosure unclear will be omitted.

When describing the embodiments of the disclosure, descriptions related to technical content that is well known in the field and not directly related to the disclosure will be omitted. Such omission of unnecessary descriptions is to prevent obscuring the main idea of the disclosure and to convey the main idea more clearly.

For the same reason, in the drawings, certain elements may be enlarged, omitted, or schematically represented. Additionally, the size of each element does not necessarily reflect its actual size. In the drawings, the same or corresponding elements have the same reference numerals.

By referring to the detailed description of the embodiments provided below in conjunction with the accompanying drawings, the advantages and features of the disclosure, as well as the manner of implementing them, will become apparent. However, the disclosure is not limited to the embodiments described below, but can be implemented in various different forms. The following embodiments are provided solely for the purpose of fully disclosing the disclosure and informing those skilled in the art about the scope of the disclosure, and the disclosure is only limited by the claims appended hereto. Throughout the specification, the same or similar reference numerals indicate the same or similar elements.

FIG. 1 illustrates an example wireless network 100 according to various embodiments of the present disclosure. The embodiment of the wireless network 100 shown in FIG. 1 is used for illustration only. Other embodiments of the wireless network 100 can be used without departing from the scope of the present disclosure.

The wireless network 100 includes a gNodeB (gNB) 101, a gNB 102, and a gNB 103. gNB 101 communicates with the gNB 102 and the gNB 103. The gNB 101 also communicates with at least one Internet Protocol (IP) network 130, such as the Internet, a private IP network, or other data networks.

Depending on a type of the network, other well-known terms such as “base station” or “access point” can be used instead of “gNodeB” or “gNB.” For convenience, the terms “gNodeB” and “gNB” are used in this patent document to refer to network infrastructure components that provide wireless access for remote terminals. And, depending on the type of the network, other well-known terms such as “mobile station,” “user station,” “remote terminal,” “wireless terminal” or “user apparatus” can be used instead of “user equipment” or “UE.” For convenience, the terms “user equipment” and “UE” are used in this patent document to refer to remote wireless devices that wirelessly access the gNB, no matter whether the UE is a mobile device (such as a mobile phone or a smart phone) or a fixed device (such as a desktop computer or a vending machine).

A gNB 102 provides wireless broadband access to the network 130 for a first plurality of User Equipments (UEs) within a coverage area 120 of the gNB 102. The first plurality of UEs includes a UE 111, which may be located in a Small Business (SB); a UE 112, which may be located in an enterprise (E); a UE 113, which may be located in a WiFi Hotspot (HS); a UE 114, which may be located in a first residence (R); a UE 115, which may be located in a second residence (R); a UE 116, which may be a mobile device (M), such as a cellular phone, a wireless laptop computer, a wireless PDA, etc. GNB 103 provides wireless broadband access to network 130 for a second plurality of UEs within a coverage area 125 of the gNB 103. The second plurality of UEs includes a UE 115 and a UE 116. In some embodiments, one or more of gNBs 101-103 can communicate with each other and with UEs 111-116 using 5G, Long Term Evolution (LTE), LTE-A, WiMAX or other advanced wireless communication technologies.

The dashed lines show approximate ranges of the coverage areas 120 and 125, and the ranges are shown as approximate circles merely for illustration and explanation purposes. It should be clearly understood that the coverage areas associated with the gNBs, such as the coverage areas 120 and 125, may have other shapes, including irregular shapes, depending on configurations of the gNBs and changes in the radio environment associated with natural obstacles and man-made obstacles.

As will be described in more detail below, one or more of the gNB 101, the gNB 102, and the gNB 103 include a 2D antenna array as described in embodiments of the present disclosure. In some embodiments, one or more of the gNB 101, the gNB 102, and the gNB 103 support codebook designs and structures for systems with 2D antenna arrays.

Although FIG. 1 illustrates an example of the wireless network 100, various changes can be made to FIG. 1. The wireless network 100 can include any number of gNBs and any number of UEs in any suitable arrangement, for example. Furthermore, the gNB 101 can directly communicate with any number of UEs and provide wireless broadband access to the network 130 for those UEs. Similarly, each gNB 102-103 can directly communicate with the network 130 and provide direct wireless broadband access to the network 130 for the UEs. In addition, the gNB 101, 102 and/or 103 can provide access to other or additional external networks, such as external telephone networks or other types of data networks.

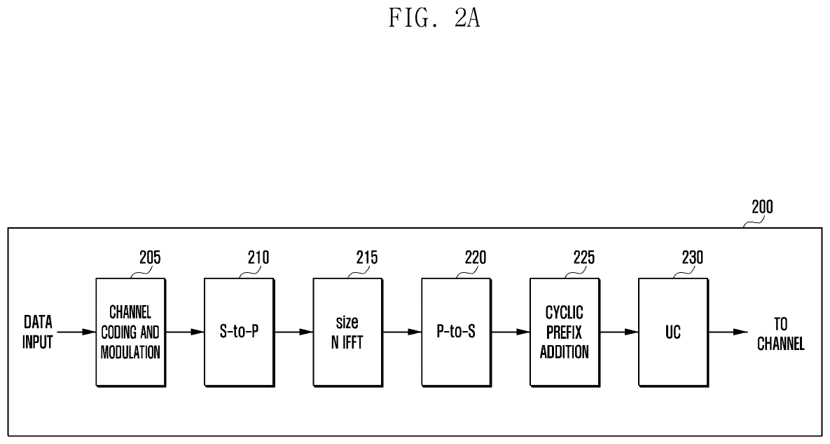

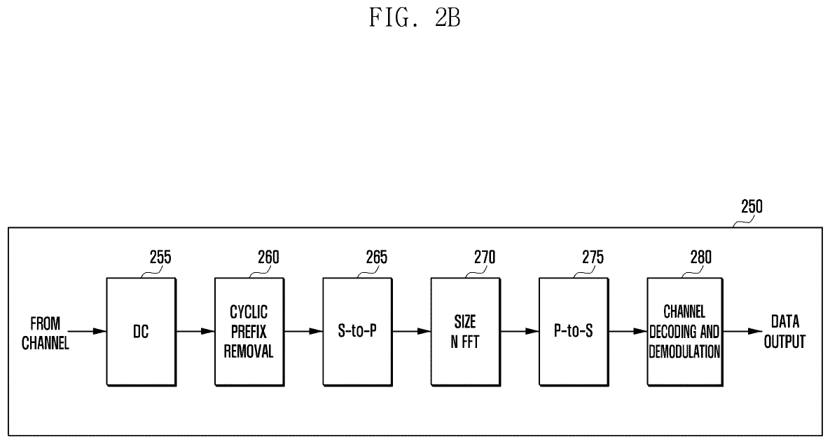

FIGS. 2A and 2B illustrate example wireless transmission and reception paths according to the present disclosure. In the following description, the transmission path 200 can be described as being implemented in a gNB, such as the gNB 102, and the reception path 250 can be described as being implemented in a UE, such as the UE 116. However, it should be understood that the reception path 250 can be implemented in a gNB and the transmission path 200 can be implemented in a UE. In some embodiments, the reception path 250 is configured to support codebook designs and structures for systems with 2D antenna arrays as described in embodiments of the present disclosure.

The transmission path 200 includes a channel coding and modulation block 205, a serial-to-parallel (S-to-P) block 210, a size N inverse fast Fourier transform (IFFT) block 215, a parallel-to-serial (P-to-S) block 220, a cyclic prefix addition block 225, and an up-converter (UC) 230. The reception path 250 includes a down-converter (DC) 255, a cyclic prefix removal block 260, a serial-to-parallel (S-to-P) block 265, a size N fast Fourier transform (FFT) block 270, a parallel-to-serial (P-to-S) block 275, and a channel decoding and demodulation block 280.

In the transmission path 200, the channel coding and modulation block 205 receives a set of information bits, applies coding (such as low density parity check (LDPC) coding), and modulates the input bits (such as using quadrature phase shift keying (QPSK) or quadrature amplitude modulation (QAM)) to generate a sequence of frequency-domain modulated symbols. The serial-to-parallel (S-to-P) block 210 converts (such as demultiplexes) serial modulated symbols into parallel data to generate N parallel symbol streams, where N is a size of the IFFT/FFT used in the gNB 102 and the UE 116. The size N IFFT block 215 performs IFFT operations on the N parallel symbol streams to generate a time domain output signal. The parallel-to-serial block 220 converts (such as multiplexes) parallel time domain output symbols from the size N IFFT block 215 to generate a serial time domain signal. The cyclic prefix addition block 225 inserts a cyclic prefix into the time domain signal. The up-converter 230 modulates (such as up-converts) the output of the cyclic prefix addition block 225 to an RF frequency for transmission via a wireless channel. The signal can also be filtered at a baseband before switching to the RF frequency.

The RF signal transmitted from the gNB 102 arrives at the UE 116 after passing through the wireless channel, and operations in reverse to those at the gNB 102 are performed at the UE 116. The down-converter 255 down-converts the received signal to a baseband frequency, and the cyclic prefix removal block 260 removes the cyclic prefix to generate a serial time domain baseband signal. The serial-to-parallel block 265 converts the time domain baseband signal into a parallel time domain signal. The size N FFT block 270 performs an FFT algorithm to generate N parallel frequency-domain signals. The parallel-to-serial block 275 converts the parallel frequency-domain signal into a sequence of modulated data symbols. The channel decoding and demodulation block 280 demodulates and decodes the modulated symbols to recover the original input data stream.

Each of gNBs 101-103 may implement a transmission path 200 similar to that for transmitting to UEs 111-116 in the downlink, and may implement a reception path 250 similar to that for receiving from UEs 111-116 in the uplink. Similarly, each of UEs 111-116 may implement a transmission path 200 for transmitting to gNBs 101-103 in the uplink, and may implement a reception path 250 for receiving from gNBs 101-103 in the downlink.

Each of the components in FIGS. 2A and 2B can be implemented using only hardware, or using a combination of hardware and software/firmware. As a specific example, at least some of the components in FIGS. 2A and 2B may be implemented in software, while other components may be implemented in configurable hardware or a combination of software and configurable hardware. For example, the FFT block 270 and IFFT block 215 may be implemented as configurable software algorithms, in which the value of the size N may be modified according to the implementation.

Furthermore, although described as using FFT and IFFT, this is only illustrative and should not be interpreted as limiting the scope of the present disclosure. Other types of transforms can be used, such as discrete Fourier transform (DFT) and inverse discrete Fourier transform (IDFT) functions. It should be understood that for DFT and IDFT functions, the value of variable N may be any integer (such as 1, 2, 3, 4, etc.), while for FFT and IFFT functions, the value of variable N may be any integer which is a power of 2 (such as 1, 2, 4, 8, 16, etc.).

Although FIGS. 2A and 2B illustrate examples of wireless transmission and reception paths, various changes may be made to FIGS. 2A and 2B. For example, various components in FIGS. 2A and 2B can be combined, further subdivided or omitted, and additional components can be added according to specific requirements. Furthermore, FIGS. 2A and 2B are intended to illustrate examples of types of transmission and reception paths that can be used in a wireless network. Any other suitable architecture can be used to support wireless communication in a wireless network.

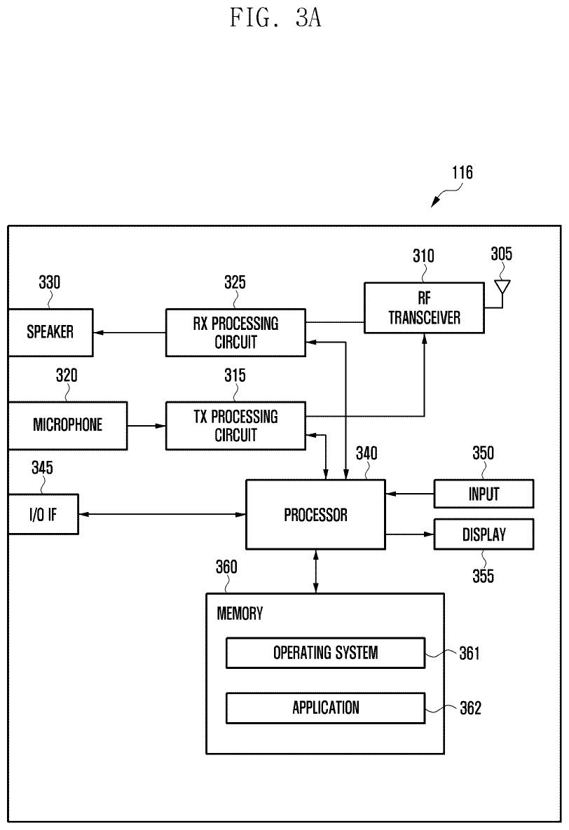

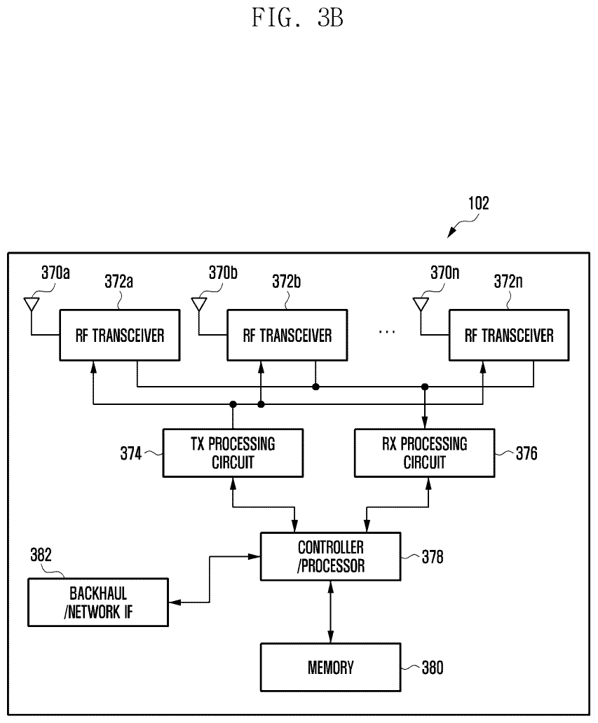

FIG. 3A illustrates an example UE 116 according to the present disclosure. The embodiment of the UE 116 shown in FIG. 3A is used for illustration only, and UEs 111-115 of FIG. 1 can have the same or similar configuration. However, a UE has various configurations, and FIG. 3A does not limit the scope of the present disclosure to any specific implementation of the UE.

A UE 116 includes an antenna 305, a radio frequency (RF) transceiver 310, a transmission (TX) processing circuit 315, a microphone 320, and a reception (RX) processing circuit 325. The UE 116 also includes a speaker 330, a processor/controller 340, an input/output (I/O) interface 345, an input device(s) 350, a display 355, and a memory 360. The memory 360 includes an operating system (OS) 361 and one or more applications 362.

The RF transceiver 310 receives an incoming RF signal transmitted by a gNB of the wireless network 100 from the antenna 305. The RF transceiver 310 down-converts the incoming RF signal to generate an intermediate frequency (IF) or baseband signal. The IF or baseband signal is transmitted to the RX processing circuit 325, where the RX processing circuit 325 generates a processed baseband signal by filtering, decoding and/or digitizing the baseband or IF signal. The RX processing circuit 325 transmits the processed baseband signal to speaker 330 (such as for voice data) or to processor/controller 340 for further processing (such as for web browsing data).

The TX processing circuit 315 receives analog or digital voice data from microphone 320 or other outgoing baseband data (such as network data, email or interactive video game data) from processor/controller 340. The TX processing circuit 315 encodes, multiplexes, and/or digitizes the outgoing baseband data to generate a processed baseband or IF signal. The RF transceiver 310 receives the outgoing processed baseband or IF signal from the TX processing circuit 315 and up-converts the baseband or IF signal into an RF signal transmitted via the antenna 305.

The processor/controller 340 can include one or more processors or other processing devices and execute an OS 361 stored in the memory 360 in order to control the overall operation of the UE 116. For example, the processor/controller 340 can control the reception of forward channel signals and the transmission of backward channel signals through the RF transceiver 310, the RX processing circuit 325 and the TX processing circuit 315 according to well-known principles. In some embodiments, the processor/controller 340 includes at least one microprocessor or microcontroller.

The processor/controller 340 is also capable of executing other processes and programs residing in the memory 360, such as operations for channel quality measurement and reporting for systems with 2D antenna arrays as described in embodiments of the present disclosure. The processor/controller 340 can move data into or out of the memory 360 as required by an execution process. In some embodiments, the processor/controller 340 is configured to execute the application 362 based on the OS 361 or in response to signals received from the gNB or the operator. The processor/controller 340 is also coupled to an I/O interface 345, where the I/O interface 345 provides the UE 116 with the ability to connect to other devices such as laptop computers and handheld computers. I/O interface 345 is a communication path between these accessories and the processor/controller 340.

The processor/controller 340 is also coupled to the input device(s) 350 and the display 355. An operator of the UE 116 can input data into the UE 116 using the input device(s) 350. The display 355 may be a liquid crystal display or other display capable of presenting text and/or at least limited graphics (such as from a website). The memory 360 is coupled to the processor/controller 340. A part of the memory 360 can include a random access memory (RAM), while another part of the memory 360 can include a flash memory or other read-only memory (ROM).

Although FIG. 3A illustrates an example of the UE 116, various changes can be made to FIG. 3A. For example, various components in FIG. 3A can be combined, further subdivided or omitted, and additional components can be added according to specific requirements. As a specific example, the processor/controller 340 can be divided into a plurality of processors, such as one or more central processing units (CPUs) and one or more graphics processing units (GPUs). Furthermore, although FIG. 3A illustrates that the UE 116 is configured as a mobile phone or a smart phone, UEs can be configured to operate as other types of mobile or fixed devices.

FIG. 3B illustrates an example gNB 102 according to the present disclosure. The embodiment of the gNB 102 shown in FIG. 3B is used for illustration only, and other gNBs of FIG. 1 can have the same or similar configuration. However, a gNB has various configurations, and FIG. 3B does not limit the scope of the present disclosure to any specific implementation of a gNB. It should be noted that the gNB 101 and the gNB 103 can include the same or similar structures as the gNB 102.

As shown in FIG. 3B, gNB 102 includes a plurality of antennas 370a-370n, a plurality of RF transceivers 372a-372n, a transmission (TX) processing circuit 374, and a reception (RX) processing circuit 376. In certain embodiments, one or more of the plurality of antennas 370a-370n include a 2D antenna array. The gNB 102 also includes a controller/processor 378, a memory 380, and a backhaul or network interface 382.

RF transceivers 372a-372n receive an incoming RF signal from antennas 370a-370n, such as a signal transmitted by UEs or other gNBs. RF transceivers 372a-372n down-convert the incoming RF signal to generate an IF or baseband signal. The IF or baseband signal is transmitted to the RX processing circuit 376, where the RX processing circuit 376 generates a processed baseband signal by filtering, decoding and/or digitizing the baseband or IF signal. RX processing circuit 376 transmits the processed baseband signal to controller/processor 378 for further processing.

The TX processing circuit 374 receives analog or digital data (such as voice data, network data, email or interactive video game data) from the controller/processor 378. TX processing circuit 374 encodes, multiplexes and/or digitizes outgoing baseband data to generate a processed baseband or IF signal. RF transceivers 372a-372n receive the outgoing processed baseband or IF signal from TX processing circuit 374 and up-convert the baseband or IF signal into an RF signal transmitted via antennas 370a-370n.

The controller/processor 378 can include one or more processors or other processing devices that control the overall operation of the gNB 102. For example, the controller/processor 378 can control the reception of forward channel signals and the transmission of backward channel signals through the RF transceivers 372a-372n, the RX processing circuit 376 and the TX processing circuit 374 according to well-known principles. The controller/processor 378 can also support additional functions, such as higher-level wireless communication functions. For example, the controller/processor 378 can perform a blind interference sensing (BIS) process such as that performed through a BIS algorithm, and decode a received signal from which an interference signal is subtracted. A controller/processor 378 may support any of a variety of other functions in the gNB 102. In some embodiments, the controller/processor 378 includes at least one microprocessor or microcontroller.

The controller/processor 378 is also capable of executing programs and other processes residing in the memory 380, such as a basic OS. The controller/processor 378 can also support channel quality measurement and reporting for systems with 2D antenna arrays as described in embodiments of the present disclosure. In some embodiments, the controller/processor 378 supports communication between entities such as web RTCs. The controller/processor 378 can move data into or out of the memory 380 as required by an execution process.

The controller/processor 378 is also coupled to the backhaul or network interface 382. The backhaul or network interface 382 allows the gNB 102 to communicate with other devices or systems through a backhaul connection or through a network. The backhaul or network interface 382 can support communication over any suitable wired or wireless connection(s). For example, when the gNB 102 is implemented as a part of a cellular communication system, such as a cellular communication system supporting 5G or new radio access technology or NR, LTE or LTE-A, the backhaul or network interface 382 can allow the gNB 102 to communicate with other gNBs through wired or wireless backhaul connections. When the gNB 102 is implemented as an access point, the backhaul or network interface 382 can allow the gNB 102 to communicate with a larger network, such as the Internet, through a wired or wireless local area network or through a wired or wireless connection. The backhaul or network interface 382 includes any suitable structure that supports communication through a wired or wireless connection, such as an Ethernet or an RF transceiver.

The memory 380 is coupled to the controller/processor 378. A part of the memory 380 can include a RAM, while another part of the memory 380 can include a flash memory or other ROMs. In certain embodiments, a plurality of instructions, such as the BIS algorithm, are stored in the memory. The plurality of instructions is configured to cause the controller/processor 378 to execute the BIS process and decode the received signal after subtracting at least one interference signal determined by the BIS algorithm.

As will be described in more detail below, the transmission and reception paths of the gNB 102 (implemented using RF transceivers 372a-372n, TX processing circuit 374 and/or RX processing circuit 376) support aggregated communication with FDD cells and TDD cells.

Although FIG. 3B illustrates an example of the gNB 102, various changes may be made to FIG. 3B. For example, the gNB 102 can include any number of each component shown in FIG. 3A. As a specific example, the access point can include many backhaul or network interfaces 382, and the controller/processor 378 can support routing functions to route data between different network addresses. As another specific example, although shown as including a single instance of the TX processing circuit 374 and a single instance of the RX processing circuit 376, the gNB 102 can include multiple instances of each (such as one for each RF transceiver).

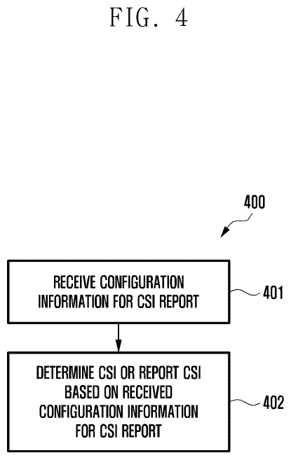

Various embodiments of the present disclosure are described in detail below with reference to the accompanying drawings. FIG. 4 illustrates a method 400 performed by a user equipment (UE) according to various embodiments of the present disclosure. The method 400 includes, at 401, the UE receiving configuration information for a CSI report; at 402, the UE determines CSI or reports CSI based on the received configuration information for the CSI report. Herein, the term “CSI report configuration (information)” may be interchangeably used with the terms “configuration information for the CSI report” and “information for configuring CSI report.”

A UE receives CSI report configuration information (e.g., csi-ReportConfig). Optionally, the CSI report configuration corresponds to first resource. Optionally, the CSI report configuration includes/is associated with information for the first resource. Here, the first resource may be used for channel measurement and/or for interference measurement. Optionally, the first resource may be one or more resources (or, all resources) in resource set(s) (e.g., NZP-CSI-RS-ResourceSet) associated with/corresponding to the CSI report configuration information. Optionally, the resource set corresponds to the CSI report configuration information. Optionally, the resource set is in CSI resource setting corresponding to the CSI report configuration information. Optionally, the CSI resource setting is used for channel measurement (or, for interference measurement). For example, the CSI resource setting is associated with/corresponding to a resource parameter for channel measurement (e.g., resourcesForChannelMeasurement) in the CSI report configuration information. The CSI resource setting is, for example, CSI-ResourceConfig. Optionally, resource may be a reference signal resource. Optionally, the reference signal resource may be a reference signal. Optionally, the reference signal includes a channel state information reference signal (CSI-RS) or a channel state information interference measurement (CSI-IM). Optionally, the CSI-RS may be a non-zero power (NZP) CSI-RS.

Optionally, the CSI report configuration information corresponds to a specific report quantity. Optionally, the CSI report configuration information includes information for the specific report quantity. In the present disclosure, terms “CSI parameter” and “CSI report quantity” may be used interchangeably. Optionally, the specific report quantity may be at least one of the followings: a CSI-RS resource indicator (CRI), an SSB resource indicator (SS/PBCH block resource indicator (SSBRI), a Layer 1-reference signal received power (L1-RSRP), a Rank indicator (RI), a precoding matrix indicator (PMI), a channel quality indicator (CQI), a layer indicator (LI), a codebook parameter i1, a codebook parameter i2. Optionally, the report quantity of the CSI report configuration information may be CRI, L1-RSRP. For example, the report quantity parameter (reportQuantity, or reportQuantity in CSI-ReportConfig) of the CSI report configuration information is set/configured (via Radio resource control (RRC) signaling) as “cri-RSRP.” Optionally, the report quantity of the CSI report configuration information may be SSBRI, L1-RSRP. For example, the report quantity parameter (reportQuantity, or reportQuantity in CSI-ReportConfig) of the CSI report configuration information is set/configured (via RRC signaling) as “ssb-Index-RSRP.” Optionally, the report quantity of the CSI report configuration information may be CRI, RI, PMI, and CQI. For example, the report quantity parameter (reportQuantity, or reportQuantity in CSI-ReportConfig) of the CSI report configuration information is set/configured (via RRC signaling) as “cri-RI-PMI-CQI.” Optionally, the report quantity of the CSI report configuration information may be CRI, RI, LI, PMI, and CQI. For example, the report quantity parameter (reportQuantity, or reportQuantity in CSI-ReportConfig) of the CSI report configuration information is set/configured (via RRC signaling) as “cri-RI-LI-PMI-CQI.” Optionally, the report quantity of the CSI report configuration information may be CRI, RI, and i1.

For example, the report quantity parameter (reportQuantity, or reportQuantity in CSI-ReportConfig) of the CSI report configuration information is set/configured (via RRC signaling) as “cri-RI-i1.” Optionally, the report quantity of CSI report may be CRI, RI, i1, and CQI. For example, the report quantity parameter (reportQuantity, or reportQuantity in CSI-ReportConfig) of the CSI report configuration information is set/configured (via RRC signaling) as “cri-RI-i1-CQI.” Optionally, the report quantity of the CSI report configuration information may be CRI, RI, and CQI. For example, the report quantity parameter (reportQuantity, or reportQuantity in CSI-ReportConfig) of the CSI report configuration information is set/configured (via RRC signaling) as “cri-RI-CQI.” The report quantity parameter of the CSI report configuration information is exemplified by being set/configured as “cri-RSRP” or “ssb-Index-RSRP.”

Optionally, the first resource is configured for beam management. Optionally, the first resource may be configured with a repetition parameter. For example, the resource set(s) (e.g., NZP-CSI-RS-ResourceSet) where the first resource is located/associated with the first resource/corresponding to the first resource is configured with the repetition parameter (e.g., repetition). Optionally, the repetition parameter may be configured as “on” or “off.” For example, the repetition parameter of the resource set where the first resource is located is set to off. Optionally, numbers of ports (e.g., numbers of CSI-RS ports) corresponding to all resources in the resource set are the same. For example, numbers of ports corresponding to all resources in the resource set are 1, or numbers of ports corresponding to all resources in the resource set are 2.

Optionally, the UE determines and/or reports a CSI parameter based on the first resource. Herein, the term “CSI parameter” may be used interchangeably with the term “CSI” or the term “parameter for the CSI report.” Optionally, determining the CSI parameter may be computing the CSI parameter. Optionally, determining the CSI parameter may be determining a CSI feedback. Determining the CSI parameter may also be determining a report carrying the CSI parameter (i.e., determining a CSI report). Optionally, the CSI parameter may be the CSI feedback. The CSI parameter may also be the report carrying the CSI parameter (i.e., the CSI report).

Optionally, the CSI parameter may be at least one of a channel state information reference signal (CSI-RS) resource indicator (CRI), a Rank indicator (RI), a precoding matrix indicator (PMI), a channel quality indicator (CQI), a layer indicator (LI). Optionally, the CSI parameter may be at least one of a CSI-RS resource indicator (CRI), an SSB resource indicator (SS/PBCH block resource indicator (SSBRI), a layer 1-reference signal received power (L1-RSRP), a layer 1-signal to interference and noise ratio (L1-SINR), a capability index (Capability Index).

The reference signal resource (e.g., one or more reference signal resources included in the first resource) may be periodic or semi-persistent. A determination method for measurement occasion group is described below by taking the first resource being periodic or semi-persistent as an example. Optionally, the first resource corresponds to one or more measurement occasion groups. For example, the one or more measurement occasion groups may be P measurement occasion group(s), where P≥1 or P>1. Optionally, each/one measurement occasion group may include one or more measurement occasions (optionally, one or more consecutive measurement occasions). Optionally, each/one measurement occasion group may include C measurement occasions (or C measurement occasions for one/each of the first resource), where C≥1. When C=1, the measurement occasion group may be equivalent to a measurement occasion. Optionally, C measurement occasions may be consecutive (in time domain). Optionally, the UE determines and/or reports the CSI parameter based on P measurement occasion groups. Optionally, the first resource includes one or more reference signal resources. For example, the first resource may include Kₛ reference signal resources, where Kₛ≥1. Optionally, the reference signal resource may be a CSI-RS (e.g., NZP CSI-RS) and/or an SSB.

Optionally, C may be predefined, for example, at least one of 1, 2, 3, 4, 8, 16. Optionally, C may be based on UE capability. For example, C is indicated by the (reported) UE capability signaling. For example, C is indicated by the base station. For example, C is configured via RRC signaling. Optionally, C is indicated by MAC-CE signaling. Optionally, MAC-CE may be a signaling for triggering the CSI report corresponding to the CSI configuration information. MAC-CE includes/corresponds to an (explicit) indication of C; or a triggering state indicated by MAC-CE includes/corresponds to the indication of C. For example, C is configured via DCI signaling. Optionally, DCI may be a signaling for triggering the CSI report corresponding to the CSI configuration information. DCI (e.g., corresponding to DCI format 0_1 or DCI format 0_2) includes/corresponds to an (explicit) indication of C; or the triggering state indicated by DCI includes/corresponds to the indication of C.

The determination method for P measurement occasion groups (corresponding to a reference signal resource) is described below by taking Kₛ=1 as an example. Optionally, P measurement occasion groups may be determined based on at least one of: a periodicity of the first resource; a CSI reference resource; a time unit where the CSI report is located.

Optionally, the CSI reference resource may be the CSI reference resource for the corresponding CSI report configuration. Optionally, the CSI reference resource may be the CSI reference resource carrying/including the CSI report of the CSI parameter. For example, P measurement occasion groups may be P consecutive measurement occasion groups (e.g., measurement occasions of neighboring measurement occasion groups are consecutive). Optionally, a last occasion group of P measurement occasion groups may be a (most recent) measurement occasion group that is no later than the CSI reference resource or earlier/no later than the time unit associated with the CSI report. Optionally, the measurement occasion group that is no later than the CSI reference resource refers to the most recent measurement occasion group in which all measurement occasions are no later than the CSI reference resource in the measurement occasion groups. Optionally, the most recent measurement occasion group that is no later than the CSI reference resource refers to the most recent measurement occasion group in which at least one measurement occasion is no later than the CSI reference resource in the measurement occasion groups.

Optionally, a first time unit where the last occasion group of P measurement occasion groups is located/associated with the last occasion group of P measurement occasion groups (e.g., the time unit where the last measurement occasion in the last occasion group is located) is determined based on the time unit associated with the CSI report. Optionally, the time unit associated with the CSI report refers to the time unit where the CSI report is located. Optionally, the time unit associated with the CSI report may be the time unit before the CSI report. Optionally, the time unit associated with the CSI report may be the first time unit. Optionally, an offset between the first time unit and the time unit where the CSI report is located is a time unit of a specific value. When the specific value is 0, the time unit is the time unit where the CSI report is located. Optionally, when the specific value is a negative value, the first time unit is before the time unit where the CSI report is located. Optionally, when the specific value is a positive value, the first time unit is after the time unit where the CSI report is located. Optionally, the specific value may be predefined, e.g., one of −1, −2, −3, −4, 0, 1, 2, 3, 4. Optionally, the specific value may be based on UE capability. Optionally, the specific value may be indicated by the (reported) UE capability signaling. Optionally, the specific value may be indicated by the base station (e.g., via at least one of RRC, medium access control-control element (MAC-CE), downlink control information (DCI)). Here, the time unit may be a slot or a symbol. Optionally, the time unit may be an uplink slot or an uplink symbol. Optionally, the time unit may be a downlink slot or a downlink symbol.

Optionally, P measurement occasion groups are equally spaced (in time domain). Optionally, a spacing may be the spacing between measurement occasions (corresponding to the same resource) in the neighboring measurement occasion groups. Optionally, the spacing may be the spacing between the (first/earliest) measurement occasions in the neighboring measurement occasion group. Optionally, the spacing may be the spacing between the (last/latest) measurement occasions in the neighboring measurement occasion group. Optionally, the spacing may be N_{period} periodicities of the first resource (N_{period}≥1). Optionally, N_{period}≥C. Optionally, the first resource may include one or more resources, and periodicities of the one or more resources are equal.

Optionally, K measurement occasions (of a resource included in the first resource) may be associated with P measurement occasion groups. Optionally, A sum of measurement occasions included in P measurement occasion groups is K (e.g., K=P*C). Optionally, K measurement occasions may be K most recent measurement occasions no later than the CSI reference resource. Optionally, K measurement occasions may be K most recent measurement occasions no later than the CSI reference resource.

Optionally, K may be predefined, for example, at least one of 1, 2, 3, 4, 8, 16. Optionally, K may be based on UE capability. For example, K is indicated by the (reported) UE capability signaling. For example, K is indicated by the base station. For example, K is configured via RRC signaling. Optionally, K may be indicated by MAC-CE signaling. Optionally, MAC-CE may be a signaling for triggering the CSI report corresponding to the CSI configuration information. MAC-CE includes/corresponds to an (explicit) indication of K; or the triggering state indicated by MAC-CE includes/corresponds to the indication of K. For example, K is configured via DCI signaling. Optionally, DCI may be a signaling for triggering the CSI report corresponding to the CSI configuration information. DCI (e.g., corresponding to DCI format 0_1 or DCI format 0_2) includes/corresponds to an (explicit) indication of K; or the triggering state indicated by DCI includes/corresponds to an indication of K.

Optionally, N_{period} may be predefined, for example, at least one of 1, 2, 3, 4, 8, 16. Optionally, N_{period} may be based on UE capability. For example, N_{period} is indicated by the (reported) UE capability signaling. For example, N_{period} is indicated by the base station. For example, N_{period} is configured via RRC signaling. Optionally, N_{period} is indicated by MAC-CE signaling. Optionally, MAC-CE may be a signaling for triggering the CSI report corresponding to the CSI configuration information. MAC-CE includes/corresponds to an (explicit) indication of N_{period}; or the triggering state indicated by MAC-CE includes/corresponds to an indication of N_{period}. For example, N_{period} is configured via DCI signaling. Optionally, DCI may be a signaling for triggering the CSI report corresponding to the CSI configuration information. DCI (e.g., corresponding to DCI format 0_1 or DCI format 0_2) includes/corresponds to an (explicit) indication of N_{period}; or the triggering state indicated by DCI includes/corresponds to an indication of N_{period}.

A determination method for mapping relationship of K measurement occasions and P measurement occasion groups is as follows. Below is described by taking Kₛ=1 as an example.

Optionally, P measurement occasion groups are determined based on the indication of the base station (e.g., via RRC signaling or MAC-CE signaling or DCI indication) and/or an order (e.g., a time order) of K measurement occasions. Below is described by taking RRC signaling as an example.

For example, measurement occasions of a resource may be numbered. For example, the most recent/last measurement occasion of a resource no later than the CSI reference resource may be numbered #1; the penultimate measurement occasion (in time domain) of a resource no later than the CSI reference resource may be numbered #2; the antepenultimate measurement occasion (in time domain) of a resource no later than the CSI reference resource may be numbered #3; and so on. It should be noted that specific values numbered above are exemplary. For example, the most recent/last measurement occasion of a resource no later than the CSI reference resource may also be numbered #0, the present disclosure is not limited thereto.

Optionally, the UE receives a signaling (e.g., one of RRC signaling, MAC-CE signaling, DCI signaling) from the base station indicating the mapping relationship of K measurement occasions and measurement occasion groups. For example, each of K measurement occasions of a resource is indicated with a group ID (e.g., 0≤group ID≤P−1). For example, an index of each of K measurement occasions of a resource is associated with/is indicated with a group ID (e.g., 0≤group ID≤P−1). A terminal device may determine which group the resource is in based on the group ID corresponding to one measurement occasion.

Optionally, the UE receives the signaling (e.g., one of RRC signaling, MAC-CE signaling, DCI signaling) from the base station, the RRC signaling indicating (e.g., explicitly indicating, or directly indicating) P and K. P may also be predefined (e.g., P=1 or 2 or 3 or 4), or P is based on UE capability (e.g., P is indicated by the reported UE capability signaling). Optionally, the number of measurement occasions (C) included in each of P measurement occasion groups is determined based on P and K. For example, C=K/P, or C is determined based on ┌K/P┘. For example, each group of the first P−1 groups includes ┌K/P┘ measurement occasions; the number of measurement occasions included in the last group is K−(P−1)*┌K/P┘. For this method, measurement occasions included in P resource groups are based on the order of K measurement occasions. Optionally, the order is, for example, the order in time domain of K measurement occasions (e.g., sequential order in time domain). Optionally, the order is, for example, the order of the indexes of K measurement occasions (e.g., an ascending or descending order of the indexes).

For example, the measurement occasion with lowest index of the first K/P measurement occasions of K measurement occasions is in the first measurement occasion group; the measurement occasion with lowest index of subsequent K/P measurement occasions is in the second measurement occasion group; and so on. Optionally, K measurement occasions may be K measurement occasions numbered #1 to #K. Optionally, K measurement occasions may be K measurement occasions numbered 1, numbered 1+m1+m2*1, numbered 1+m1+m2*2, . . . , numbered 1+m1+m2*(K−1). Optionally, m1 may be indicated by the base station. For example, m1 may be indicated via at least one of RRC signaling, MAC-CE signaling, DCI. Optionally, m1 may be predefined. For example, m1 may be at least one of 0, 1, 2, 3, 4. Optionally, m2 may be indicated by the base station. For example, m2 may be indicated via at least one of RRC signaling, MAC-CE signaling, DCI. Optionally, m2 may be predefined. For example, m2 may be at least one of 0, 1, 2, 3, 4. Optionally, m1 and or m2 may be an integer not less than 0.

Optionally, the UE receives a signaling (e.g., one of RRC signaling, MAC-CE signaling, DCI signaling) from the base station indicating (e.g., explicitly indicating, or directly indicating) P and C. In this case, C represents the number of measurement occasions included in each measurement group, and K=C*P. For this method, measurement occasions included in P resource groups are based on the order of K measurement occasions. Optionally, the order is, for example, the order in time domain of K measurement occasions (e.g., sequential order in time domain). Optionally, the order is, for example, the order of the indexes of K measurement occasions (e.g., an ascending or descending order of the indexes). For example, the measurement occasion with lowest index of the first C measurement occasions of K measurement occasions is in the first measurement occasion group; the measurement occasion with lowest index of the subsequent C measurement occasions is in the second measurement occasion group; and so on. Optionally, K measurement occasions may be K most recent measurement occasions (of a resource) that are no later than the CSI reference resource. Optionally, K measurement occasions may be K measurement occasions numbered 1, numbered 1+m1+m2*1, numbered 1+m1+m2*2, . . . , numbered 1+m1+m2*(K−1). Optionally, m1 may be indicated by the base station. For example, m1 may be indicated via at least one of RRC signaling, MAC-CE signaling, DCI. Optionally, m1 may be predefined. For example, m1 may be at least one of 0, 1, 2, 3, 4. Optionally, m2 may be indicated by the base station. For example, m2 may be indicated via at least one of RRC signaling, MAC-CE signaling, DCI. Optionally, m2 may be predefined. For example, m2 may be at least one of 0, 1, 2, 3, 4. Optionally, m1 and/or m2 may be an integer not less than 0.

The determination method for P measurement occasion groups (corresponding to one or more reference signal resources) is described below by taking Kₛ≥1 as an example. Optionally, refer to the determination method described above for Kₛ=1 for the determination method for measurement occasion groups for one (or each) of Kₛ resources. Optionally, P measurement occasion groups are determined based on measurement occasion groups corresponding to each (or, one) of Kₛ resources. Optionally, P measurement occasion groups are determined based on measurement occasion groups corresponding to each (or, one) of Kₛ resources and the time order of measurement occasion groups. For example, based on the time order of P measurement occasion groups, the first measurement occasion group includes the first measurement occasion group for each (or one) of Kₛ resources; the second measurement occasion group includes the second measurement occasion group for each (or one) of Kₛ resources; and so on.

Another determination method for P measurement occasion groups (corresponding to a reference signal resource) is described below by taking Kₛ≥1 as an example. Optionally, P measurement occasion groups correspond to P windows/measurement windows. Optionally, one (or, each) of P measurement occasion groups may include (one, some, or all) measurement occasions corresponding to Kₛ resources within a window (e.g., a measurement window) corresponding to the measurement occasion group. Optionally, one (or, each) of P measurement occasion groups may include (one, some, or all) measurement occasions corresponding to Kₛ resources within the window (e.g., the measurement window) corresponding to the measurement occasion group.

A determination method for P windows corresponding to P measurement occasion groups is described below. For example, a time domain position where the last window (e.g., the first time unit/last time unit of the window) of P windows is located is determined. For example, positions where other windows are located may be further determined based on the time domain position where the last window is located.

Optionally, the time domain position of the last window (or each window) of P windows may be determined based on at least one of: the CSI reference resource; the time unit where the CSI report is located; SFN (optionally, SFN=0). Optionally, the CSI reference resource may be the CSI reference resource for the corresponding CSI report configuration. Optionally, the CSI reference resource may be the CSI reference resource carrying/including the CSI report of the CSI parameter.

The following method may determine the time domain position of the last measurement window of P measurement windows through the time domain position of the CSI reference resource or the time domain position of the CSI report, facilitating same understanding by the base station and the UE for the measurement window, and improving the reliability of the communication system.

Optionally, an offset between the measurement window (e.g., the last window of P windows) and the CSI reference resource is at least one of predefined, indicated by the base station, based on UE capability. Optionally, the offset between the ending (or, the last time unit) of the measurement window (e.g., the last window of P windows) and the CSI reference resource is at least one of predefined, indicated by the base station, based on UE capability. Take a slot as an example, the offset between the slot where the CSI reference resource is located and the last slot of the last measurement window of P windows is offset_window_slot slots. For example, a value of the offset is 0, 1, 2, 3. When the value of the offset is 0, the last slot of the measurement window is in the slot where the CSI reference resource is located. Optionally, when the value of the offset is greater than 0, the measurement window may precede the CSI reference resource. Optionally, an ending symbol of the last window of P windows may be the last symbol of the last slot. Optionally, the ending symbol of the last window of P windows may be a specific symbol of the last slot. The offset between the specific symbol and the last (or first) symbol of the last slot may be offset_window_symbol symbols.

For example, the value of the offset is one of 0, 1, 2, 3, . . . , 13. Optionally, offset_window_slot and/or offset_window_symbol may be predefined (e.g., the value may be one of 0, 1, 2, 3, . . . , 13). Optionally, offset_window_slot and/or offset_window_symbol may be indicated by the base station. For example, offset_window_slot and/or offset_window_symbol may be indicated via at least one of RRC signaling, MAC-CE signaling, DCI. Optionally, offset_window_slot and/or offset_window_symbol may be based on UE capability. For example, offset_window_slot and/or offset_window_symbol may be indicated by the reported UE capability signaling.

Optionally, the offset between the measurement window (e.g., the last window of P windows) and the CSI report (e.g., the CSI report carrying the CSI parameter) is at least one of predefined, indicated by the base station, based on UE capabilities. Optionally, the offset between the ending (or, the last time unit) of the measurement window (e.g., the last window of P windows) and the time unit where the CSI parameter is reported is at least one of predefined, indicated by the base station, based on UE capabilities. Take a slot as an example, the offset between the slot where the CSI parameter is reported and the last slot of the last measurement window of P windows is offset_window_slot slots. For example, the value of the offset is 0, 1, 2, 3, n_{ref}, n_{ref}+1, n_{ref}+2. Here, n_{ref} represents the slot where the CSI reference resource is located. For example, when the slot where the CSI report is located is slot n, the slot where the CSI reference resource is slot n-n_{ref}. When the value of the offset is 0, the last slot of the measurement window is in the slot where the CSI parameter is reported. Optionally, when the value of the offset is greater than 0, the measurement window may precede the slot where the CSI parameter is reported. Optionally, the ending symbol of the last window of P windows may be the last symbol of the last slot.

Optionally, the ending symbol of the last window of P windows may be a specific symbol of the last slot. The offset between the specific symbol and the last (or first) symbol of the last slot may be offset_window_symbol symbols. For example, the value of the offset is one of 0, 1, 2, 3, . . . , 13. Optionally, offset_window_slot and/or offset_window_symbol may be predefined (e.g., the value may be one of 0, 1, 2, 3, . . . , 13). Optionally, offset_window_slot and/or offset_window_symbol may be indicated by the base station. For example, offset_window_slot and/or offset_window_symbol may be indicated via at least one of RRC signaling, MAC-CE signaling, DCI. Optionally, offset_window_slot and/or offset_window_symbol may be based on UE capability. For example, offset_window_slot and/or offset_window_symbol may be indicated by the reported UE capability signaling.

The following method may determine time domain positions of one or more measurement windows based on the first resource (e.g., based on the periodicity of the first resource and/or SFN) and identify a window (or an ending unit of the window) with a condition being met as the last window (or as the ending time unit of the last window) of P windows, thereby facilitating the same understanding by the base station and the UE for the measurement window, improving the reliability of the communication system.

The method for determining time domain positions of one or more measurement windows based on the first resource is described below.

Optionally, one or more windows (e.g., measurement windows) are determined based on the first resource.

Optionally, a length of one (or each) of the one or more windows may be determined based on the periodicity of the first resource. For example, the length of the window is equal to the length of T (T≥1) periodicities of the first resource. Optionally, T may be predefined, e.g., one of 1, 2, 3, 4. Optionally, the length of one (or each) of the one or more windows may be determined by T time units. Optionally, the time unit may be a slot or a symbol. Optionally, the slot may be an uplink slot or a downlink slot. Optionally, the time unit may be a millisecond or a frame or a subframe. For example, when the first resource includes one or more synchronization signal blocks (SSBs) (e.g., SSB resources), the length corresponding to T time units may be a half frame/5 ms/10 ms/20 ms. Advantage for doing so is that the measurement occasion for SSB is usually within a window of a half frame/5 ms/10 ms/20 ms, and the length of Tis 5 ms/10 ms/20 ms. The length of the measurement window may be defined in a predefined manner, reducing the signaling overhead and improving the performance of the communication system. Optionally, T may be based on UE capability. Optionally, T may be indicated by the (reported) UE capability signaling. Optionally, T may be indicated by the base station (e.g., via at least one of RRC, MAC-CE, DCI). Optionally, T may be equal to C.

Optionally, one (or each) of the one or more windows may be determined based on the periodicity of the first resource and/or SFN. Optionally, the starting and/or ending (e.g., starting time unit and/or ending time unit) of one (or each) of the one or more windows may be determined based on the periodicity of the first resource and/or SFN. Optionally, one window (or, at least one window, or each window) of the one or more windows may be/may include T (consecutive) periodicities of the first resource. For example, the starting time unit of the window refers to the starting unit of the earliest one of T periodicities; the ending time unit of the window refers to the ending time unit of the last one of T periodicities. Optionally, the starting and/or ending of one (or each) of the one or more windows may be determined based on SFN numbered 0 (e.g., SFN=0) and/or a specific offset (offset_RS). Optionally, the one or more windows refer to windows that the offset between (the starting and/or ending of) the window and SFN numbered 0 (e.g., SFN=0) satisfies the relationship of being an integer multiple of the periodicity (e.g., an integer multiple of the periodicity of the first resource) and/or the specific offset (offset_RS).

For example, the offset between the starting time unit and/or the ending time unit of one (or each) of the one or more windows and SFN numbered 0 is (or is associated with) an integer multiple of the periodicity of the first resource. For example, the offset between the starting time unit and/or ending time unit of one (or each) of the one or more windows and the (starting time unit and/or ending time unit of) SFN numbered 0 is (or is associated with) an integer multiple of the periodicity of the first resource. For example, the offset between the starting time unit and/or the ending time unit of one (or each) of the one or more windows and SFN numbered 0 is (or is associated with) a sum of the integer multiple of the periodicity of the first resource and offset_RS time units. For example, the offset between the starting time unit and/or ending time unit of one (or each) of the one or more windows and the (starting time unit and/or ending time unit of) SFN numbered 0 is the sum of offset_RS and an integer multiple of the periodicity of the first resource. Optionally, refer above for the description of the time unit.

For example, the offset between the first symbol of SFN number 0 and the first symbol of the one or more windows is x*T_RS+offset_RS ms/slots. Here, x may be an integer not less than 0; T_RS corresponds to the periodicity of the first resource (e.g., the periodicity is T_RS ms/slots). Here, the time unit corresponding to offset_RS may be at least one of a frame, a subframe, a slot, a symbol, a millisecond, a second. Here, the one or more windows may be one or more windows for which the offset between the first slot/symbol of the window and the first symbol of SFN numbered 0 satisfies x*T_RS+offset_RS ms/slots/symbols.

Optionally, the starting and/or ending of one window or one of more (or each window) may be determined based on SFN numbered 0 (e.g., SFN=0) and/or the specific offset (T_{offset}). Optionally, definition of CSI-RS periodicity (e.g., the periodicity of the CSI resource corresponding to the periodicity of the first resource) is described below by an example. For example, when T_{offset} is 0, the UE may assume that SFN and/or slot number corresponding to the starting slot of the periodicity (e.g., the slot index corresponding to the starting slot and the corresponding SFN and/or slot number) of the CSI-RS resource satisfies the following equation. For example, when T_{offset} is 0, the UE may assume that the one or more windows refer to one or more windows for which SFN and/or slot number corresponding to the starting slot (e.g., the slot index corresponding to the starting slot and the corresponding SFN and/or slot number) satisfies the following equation.

For example, when T_{offset} is replaced with T_{offset}−1, the UE may assume that SFN and/or slot number corresponding to the ending slot of the periodicity (e.g., the slot index corresponding to the ending slot and the corresponding SFN and/or slot number) of the CSI-RS resource satisfies the following equation. For example, when T_{offset} is replaced with T_{offset}−1, the UE may assume that the one or more windows refer to one or more windows for which SFN and/or slot number corresponding to the ending slot (e.g., the slot index corresponding to the ending slot and the corresponding SFN and/or slot number) satisfies the following equation. Optionally, the UE determines/assumes that SFN and/or slot number corresponding to the slot of CSI-RS transmission (or SFN and/or slot number corresponding to the starting slot of one or more windows, or SFN and/or slot number corresponding to the ending slot of one or more windows) satisfies the following equation:

$$( {N}_{slot}^{frame , μ} {n}_{f} + {n}_{s , f}^{μ} - {T}_{offset} ) mod {T}_{CSI - RS} = 0.$$

Wherein T_{CSI-RS} is the length of the periodicity (in slots); T_{offset} is the offset of the time unit. Optionally, both parameters are obtained from the higher layer parameter (for CSI-RS or corresponding to the first resource) (e.g., (SI-ResourcePeriodicityAndOffset, slotConfig, or periodicityAndOffset-rl7). Optionally, T_{CSI-RS} may be determined based on the higher layer parameter (for CSI-RS r corresponding to the first resource) (e.g., (SI-ResourcePeriodicityAndOffset, slotConfig, or periodicityAndOffset-rl7). Nₛₗₒₜ^{frame,μ} represents the number of slots per frame for subcarrier spacing configuration μ. μ represents/corresponds to subcarrier spacing configuration, for example, subcarrier spacing configuration for CSI-RS. For example, subcarrier spacing configuration (of downlink bandwidth part (BWP)) transmitting the CSI-RS. n_{s,f}^{μ} represents the slot number within a frame for subcarrier spacing configuration μ. n_{f} represents the system frame number (SFN). SFN and/or slot number corresponding to the starting slot/ending slot of a CSI-RS period (or, SFN and/or slot number corresponding to the starting slot or ending slot of one or more windows) may satisfy the equation (Nₛₗₒₜ^{frame,μ}n_{f}+n_{s,f}^{μ}−T_{offset,1}) mod T_{CSI-RS}=0. Optionally, T_{CSI-RS} is the length of the periodicity of the first resource (in slots), or the length of an integer multiple of the periodicity of the first resource. For example, the multiple corresponding to the integer multiple may be predefined (e.g., 1 or 2) or the multiple corresponding to the integer multiple is indicated by the base station.

For example, the UE may assume that the one or more windows for which SFN and/or slot number corresponding to the ending slot/starting slot (e.g., the slot index corresponding to the ending slot/starting slot and the corresponding SFN) satisfies the above equation. Optionally, the length of a CSI-RS period (or an integer multiple of the periodicity of the first resource) corresponds to T_{CSI-RS} (e.g., T_{CSI-RS} represents the number of slots of the period, a CSI-RS period is T_{CSI-RS} slots). Optionally, T_{offset,1} may be 0. Optionally, T_{offset,1} may be determined based on the minimum/maximum T_{offset} in corresponding ones for Kₛ resources included in the first resource. For example, T_{offset,1} may be equal to the minimum/maximum T_{offset} in corresponding ones for Kₛ resources included in the first resource. Optionally, T_{offset,1} may be based on UE capability. For example, T_{offset,1} may be indicated by the (reported) UE capability signaling. For example, T_{offset,1} may be indicated by the base station. For example, T_{offset,1} may be indicated (via at least one of RRC, MAC-CE, DCI).

Optionally, the last window of P windows may be determined based on one or more windows determined by the first resource, or the starting/ending (e.g., starting time unit/ending time unit) of the last window of P windows may be determined based on the starting/ending (e.g., starting time unit/ending time unit) of one or more windows determined by the first resource.

Optionally, (the starting time unit/ending time unit of) the last window of P windows may be/include (the starting time unit/ending time unit of) the last window no later than the CSI reference resource or earlier/no later than the time unit associated with the CSI report in the one or more windows determined based on the first resource (e.g., the one or more windows determined by the method described above). Optionally, the one or more windows are one or more windows corresponding to the first resource. Optionally, the one or more windows are determined based on the periodicity of the first resource and/or the offset associated with the periodicity of the first resource and/or SFN (e.g., the one or more windows may be determined based on the periodicity of the first resource and/or SFN through the method described above).

Optionally, the last window of the one or more windows that is no later than the CSI reference resource or earlier/no later than the time unit associated with the CSI report may refer to the window in which all (or, at least one) measurement occasions are no later than the CSI reference resource or earlier/no later than the time unit associated with the CSI report. Optionally, the last window of the one or more windows that is no later than the CSI reference resource or earlier/no later than the time unit associated with the CSI report may refer to the window in which each of all resources (e.g., Kₛ resources) have at least one measurement occasion no later than the CSI reference resource or earlier/no later than the time unit associated with the CSI report. Optionally, the last window of the one or more windows that is no later than the CSI reference resource or earlier/no later than the time unit associated with the CSI report may refer to the window with its ending time unit is no later than the CSI reference resource or earlier/no later than the time unit associated with the CSI report. Optionally, the last window of the one or more windows that is no later than the CSI reference resource or earlier/no later than the time unit associated with the CSI report may refer to the window with its ending time unit is no later than the CSI reference resource or earlier/no later than the time unit associated with the CSI report. Here, refer above for the description of the time unit associated with the CSI report.

Optionally, the one or more windows determined based on the first resource may be numbered. For example, the last window no later than the CSI reference resource in the one or more windows is numbered #1; the penultimate window no later than the CSI reference resource in the one or more windows is numbered ##2; and so on. The above method is exemplified by an example where (the starting time unit/ending time unit of) the last window of P windows being determined based on (the starting time unit/ending time unit of) the window #1. Optionally, it is also exemplified by an example where (the starting time unit/ending time unit of) the last window of P windows being determined based on (the starting time unit/ending time unit of) the window #w. Optionally, w is greater than or equal to 1. Optionally, w may be predefined. For example, w may be at least one of 1, 2, 3, 4. Optionally, w may be indicated by the base station. For example, w may be indicated via at least one of RRC signaling, MAC-CE signaling, DCI signaling. Optionally, w may be based on UE capability. For example, w may be indicated by the (reported) UE capability signaling.

Optionally, the length of one (or each) of P windows may be determined based on the periodicity of the first resource. For example, the length of the window is equal to the length of T (T≥1) periodicities of the first resource. Optionally, T may be predefined, e.g., one of 1, 2, 3, 4. Optionally, the length of one (or each) of P windows may be determined by T time units. Optionally, the time unit may be a slot or a symbol. Optionally, the slot may be an uplink slot or a downlink slot. Optionally, the time unit may be a millisecond or a frame or a subframe. For example, when the first resource includes one or more synchronization signal blocks (SSBs) (e.g., SSB resources), the length corresponding to T time units may be a half frame/5 ms/10 ms/20 ms. Advantage for doing so is that the measurement occasion for SSB is usually within a window of a half frame/5 ms/10 ms/20 ms, and the length of Tis 5 ms/10 ms/20 ms. The length of the measurement window may be defined in a predefined manner, reducing the signaling overhead and improving the performance of the communication system. Optionally, T may be based on UE capability. Optionally, T may be indicated by the (reported) UE capability signaling. Optionally, T may be indicated by the base station (e.g., via at least one of RRC, MAC-CE, DCI). Optionally, T may be equal to C.

Optionally, when the first resource includes one or more SSBs (or SSB resources), the unit corresponding to the periodicity of the first resource is a millisecond. Optionally, the periodicity of the first resource is the periodicity of SSB. Optionally, when the first resource includes one or more SSBs (or SSB resources), one (or each) of P measurement occasion groups may include (one, some, or all) measurement occasions corresponding to Kₛ resources within one or more (consecutive) SSB bursts corresponding to the one (or, each) measurement occasion group. Optionally, when the first resource includes one or more SSBs (or SSB resources), the measurement window is the half frame where SSB is located. For example, the starting time unit of the window refers to the starting time unit of the half frame where SSB (or SSB burst) is located; the ending time unit of the window refers to the ending time unit of the half frame where SSB (or SSB burst) is located. Here, the time unit may be a slot or a symbol.

Optionally, when the first resource includes one or more CSI-RSs (or CSI-RS resources), the unit corresponding to the periodicity of the first resource is a slot. Optionally, the periodicity of the first resource is the periodicity of the CSI-RS. For example, the starting time unit of the window refers to the starting time unit of the periodicity corresponding to one or more resources (e.g., CSI-RS resources) included in the first resource; the ending time unit of the window refers to the ending time unit of the periodicity corresponding to one or more resources included in the first resource. Here, the time unit may be a slot or a symbol.

Optionally, the measurement window may be the measurement window aligned with a boundary of the periodicity of the first resource. For example, the starting or ending of the measurement window may be aligned with the boundary of the periodicity (or the starting or ending of the periodicity) of the first resource.

Optionally, P windows are equally spaced or P windows have equal offset. For example, all windows of P windows are arranged in time order, and spacings between each two neighboring windows are equal. Optionally, the spacing may be the spacing/offset between neighboring windows. Optionally, the spacing/offset may be the spacing/offset between the starting time unit or the ending time unit between neighboring windows. Optionally, the spacing/offset may be/equal to N_{period} periodicities of the first resource (N_{period}≥1). Optionally, N_{period}≥ C. Optionally, N_{period} and C are described above.

Optionally, the spacings/offsets between the P−1 windows (other than the last window, or the first P−1 windows) and the last window are determined separately (e.g., being multiples of the periodicity of the first resource, respectively). For example, the spacing/offset (with respect to the time unit) between the last window and a window of the P−1 windows is a specific value. Optionally, the specific value may be predefined. For example, the specific value is at least one of 1, 2, 3, 4, 8, 16. Optionally, the specific value may be based on UE capability. For example, the specific value is indicated by the (reported) capability signaling. Optionally, the specific value may be indicated by the base station. For example, the specific value is indicated via at least one of RRC, MAC-CE, DCI. Optionally, the time unit may be a slot or a symbol. Optionally, the slot may be an uplink slot or a downlink slot.

Optionally, the periodicity of the first resource may be the periodicity of Kₛ resources included in the first resource (e.g., Kₛ resources have same periodicities). Optionally, the periodicity of the first resource is determined based on one of the periodicities of Kₛ resources included in the first resource (e.g., Kₛ resources have different periodicities). Optionally, the periodicity of the first resource is determined based on the longest or shortest periodicity in the periodicities of Kₛ resources included in the first resource. For example, the periodicity of the first resource is equal to the longest of the periodicities of Kₛ resources included in the first resource. For example, the periodicity of the first resource is equal to the shortest of the periodicities of Kₛ resources included in the first resource. Optionally, the periodicity of the first resource is determined based on the periodicity of the first resource or the resource with the highest identification (ID)/lowest ID of Kₛ resources included in the first resource.

For example, the periodicity of the first resource is equal to the periodicity of the first resource or the resource with the highest ID/lowest ID in Kₛ resources included in the first resource. Optionally, the periodicity of the first resource is determined based on a parameter P (P>0). For example, the periodicity of the first resource may be P time units (e.g., slots or symbols) or P milliseconds/subframes/seconds. Optionally, the periodicity of the first resource may be determined based on P and one of the periodicities of Kₛ resources included in the first resource. For example, the periodicity of the first resource may be determined by the larger one of the periodicity corresponding to P and one of the periodicities of Kₛ resources. For example, the periodicity of the first resource may be determined by the smaller one of the periodicity corresponding to P and one of the periodicities of Kₛ resources.

The reference signal resource, e.g., one or more reference signal resources included in the first resource, may be periodic or semi-persistent or aperiodic. A determination method for the resource group is described below by taking the first resource being aperiodic as an example.

A determination method for P resource groups is described below. The method may obtain a plurality of resource groups by dividing the resource group and obtain the time domain position corresponding to each resource group accordingly, whereby the UE and the base station may have the same understanding of the plurality of resource groups, improving reliability of the communication system. In addition, the UE may also provide CSI parameter information related to the time domain through the report of the CSI corresponding to each resource group so as for prediction by the base station, improving performance of the communication system.

Optionally, the first resource includes Kₛ resources. Optionally, the resource corresponding to the first resource may be aperiodic. Optionally, the resource corresponding to the first resource may be periodic or semi-persistent. Optionally, the first resource group is in one or more time units. Optionally, the first resource group is in one or more slots. Optionally, the time unit may be a slot or a symbol. Optionally, the slot may be an uplink slot or a downlink slot.

Optionally, the UE may receive a DCI (in slot n), which is used to trigger aperiodic CSI report and/or aperiodic resource (e.g., the first resource). For example, the CSI report configuration information corresponds to the aperiodic CSI report. The UE receives the DCI (in slot n) for triggering the aperiodic CSI report and/or the (aperiodic) first resource corresponding to the CSI report. Optionally, the time resource at which the first resource is transmitted (by the base station) is determined based on slot n+X. Here, X represents a CSI-RS triggering offset. Optionally, the triggering offset is determined based on an aperiodic triggering offset parameter (e.g., aperiodicTriggeringOffset). Optionally, the CSI-RS triggering offset corresponds to the first resource. For example, the first resource corresponds to one or more resources in a resource set (e.g., NZP-CSI-RS-Resource Set). The resource set may be configured with the aperiodic triggering offset parameter (e.g., aperiodicTriggeringOffset). Here, slot n+X may be referred as a reference slot.

Optionally, Kₛ resources included in the first resource corresponds to one or more slots. Optionally, the slot corresponding to a resource may be the slot where the resource is located, or the slot where the resource is transmitted. Optionally, the slot corresponding to one (or at least one, or each) of Kₛ resources is determined based on a first offset and/or the reference slot (e.g., slot n+X). Optionally, the one or more slots are determined based on the reference slot and Kₛ first offsets (respectively). Optionally, the unit corresponding to the first offset may be a slot or a symbol. For example, the first offset is Y1 slots, Y1≥0. Optionally, the slot may be an uplink slot or a downlink slot. Optionally, the slot where one (or at least one, or each) of the first resource is located/transmitted is the slot (e.g., slot n+X+Y1) after Y1 slots subsequent to the reference slot.

Optionally, the first offset may be predefined, e.g., Y1 may be one of 0, 1, 2, 3, 4. Optionally, the time unit may be a slot or a symbol. Optionally, the slot may be an uplink slot or a downlink slot. Optionally, Y1 may be based on UE capability. Optionally, Y1 may be indicated by the (reported) UE capability signaling. Optionally, Y1 may be indicated by the base station (e.g., via at least one of RRC, MAC-CE, DCI). Optionally, when Y1 is not configured, the value (or default value) of Y1 is 0.

Optionally, Kₛ resources included in the first resource may be divided into P resource groups. Optionally, a resource group (or at least a resource group, or each resource group) of P resource groups corresponds to one or more slots related to the reference slot (e.g., slot n+X). Optionally, the reference slot is determined based on the CSI-RS triggering offset corresponding to the first resource. Refer above for specific description of the reference slot.

Optionally, the slot where the resources in one (or at least one, or each) of P resource groups are transmitted is determined based on one or more slots related to the reference slot (e.g., slot n+X). How the one or more slots are determined is explained further below.

Optionally, the one or more slots are determined based on the spacing of two adjacent resource groups from P resource groups. Optionally, the spacing of the two adjacent resource groups refers to the spacing between resources (e.g., first resource/last resource/earliest resource/latest resource) in the two adjacent resource groups. Optionally, the spacing may be specific (consecutive) time unit(s). For example, the length of the spacing is G time units, G≥0. Here, the time unit may be a slot or a symbol. Optionally, the slot may be an uplink slot or a downlink slot. Take a slot as an example, when the spacing of two neighboring resource groups of P resource groups is G slots, the slot where the first resource group of P resource groups is located or the (first/earliest) slot corresponding to the first resource group is the reference slot (e.g., slot n+X); the slot where the second resource group of P resource groups is located or the (first/earliest) slot corresponding to the second resource group is the slot (e.g., slot n+X+G) after G slots subsequent to the reference slot; and so on.

Optionally, the time unit spacing may be predefined, for example, at least one of 1, 2, 3, 4, 8, 16. Optionally, G may be based on UE capability. For example, G may be indicated by the (reported) UE capability signaling. For example, the time unit spacing is indicated by the base station. For example, G may be configured via RRC signaling. For example, G may be configured via MAC-CE signaling. Optionally, MAC-CE may be a signaling for triggering the CSI report corresponding to the CSI configuration information. MAC-CE includes/corresponds to an (explicit) indication of G; or the triggering state indicated by MAC-CE includes/corresponds to an indication of G. For example, the time unit spacing may be indicated by DCI signaling. Optionally, DCI may be a signaling for triggering the CSI report corresponding to the CSI configuration information. DCI (e.g., corresponding to DCI format 0_1 or DCI format 0_2) includes/corresponds to an (explicit) indication of G; or the triggering state indicated by DCI includes/corresponds to an indication of G.

Optionally, the one or more slots are determined based on a second offset corresponding to one (or at least one, or each) of P resource groups. Optionally, the unit corresponding to the second offset may be a slot or a symbol. For example, the second offset is Y2 slots, Y2≥0. Optionally, the slot may be an uplink slot or a downlink slot. Optionally, the (first/earliest) slot corresponding to a resource group (or, at least a resource group, or each resource group) of P resource groups is the slot (e.g., slot n+X+Y2) after Y2 slots subsequent to the reference slot.

Optionally, the second offset may be predefined, for example, Y2 may be one of 0, 1, 2, 3, 4. Optionally, the time unit may be a slot or a symbol. Optionally, the slot may be an uplink slot or a downlink slot. Optionally, the second offset may be based on UE capability. For example, Y2 may be indicated by the (reported) UE capability signaling. Optionally, the second offset (e.g., Y2) may be indicated by the base station (e.g., via at least one of RRC, MAC-CE, DCI).

Optionally, if a resource group (of P resource groups) corresponds to a slot, all resources in P resource groups correspond to (or are all in or are transmitted in) the slot. Optionally, if a resource group (of P resource groups) corresponds to one or more slots, especially in the case of multiple slots, additional information is needed to further determine which resources in the resource group correspond to which slots.

The mapping relationship of the resources in the resource group and the corresponding slots may be determined through the following method, so that the terminal device and the network device have the same understanding of the time domain positions of the resources, thereby improving the reliability of the communication system. Optionally, relative position of the resource in a resource group (or at least a resource group, or each resource group) of P resource groups is determined based on one or more third offsets corresponding to each resource group. Optionally, a resource (or, at least a resource, or each resource) in a resource group (or, at least a resource group, or each resource group) of P resource groups corresponds to one or more third offsets. Optionally, the unit corresponding to the third offset may be a slot or a symbol. For example, the third offset is Y3 slots, Y3≥0. Optionally, the slot may be an uplink slot or a downlink slot. Optionally, the slot corresponding to a resource (or, at least a resource, or each resource) in a resource group is the slot (e.g., slot n+X+Y2+Y3) after Y3 slots subsequent to the (earliest/first) slot of the resource group. Optionally, the determination method for the (earliest/first) slot of the resource group is described above.

Optionally, the third offset may be predefined, for example, Y3 may be one of 1, 2, 3, 4. Optionally, the time unit may be a slot or a symbol. Optionally, the slot may be an uplink slot or a downlink slot. Optionally, the third offset may be based on UE capability. For example, Y3 may be indicated by the (reported) UE capability signaling. Optionally, the third offset (e.g., Y3) may be indicated by the base station (e.g., via at least one of RRC, MAC-CE, DCI).

Optionally, relative position of the resource in a resource group (or, at least a resource group, or each resource group) of P resource groups is determined based on the order of (all) the resource in that resource group. Optionally, the order may be the order of the resource IDs (e.g., ascending or descending order of IDs). For example, the resource with the smallest ID in the resource group corresponds to the (earliest/first) slot (e.g., slot n+X+Y2) corresponding to the resource group; the resource with the second smallest ID in the resource group corresponds to the next slot (e.g., slot n+X+Y2+1) to the (earliest/first) slot corresponding to the resource group, and so on. For example, the resource with the smallest ID in the resource group corresponds to the (earliest/first) slot (e.g., slot n+X+Y2) corresponding to the resource group; the resource with the second smallest ID in the resource group corresponds to the slot (e.g., slot n+X+Y2+2) after and offset from the (earliest/first) slot corresponding to the resource group by 2, and so on. Optionally, the order may be the order of the resources in the configuration signaling (or the order in the resource group).

For example, the first resource in the resource group corresponds to the (earliest/first) slot corresponding to the resource group (e.g., slot n+X+Y2); the second resource in the resource group corresponds to the next slot (e.g., slot n+X+Y2+1) to the (earliest/first) slot corresponding to the resource group, and so on. For example, the first resource in the resource group corresponds to the (earliest/first) slot corresponding to the resource group (e.g., slot n+X+Y2); the second resource in the resource group corresponds to the slot after and offset from the (earliest/first) slot corresponding to the resource group by 2 (e.g., slot n+X+Y2+2), and so on.

Optionally, P resource groups (or the resources included in P resource groups) are determined based on the indication by the base station (e.g., via RRC signaling or MAC-CE signaling or DCI indication) and/or the order of Kₛ resources. Below is described by taking RRC signaling as an example.

Optionally, the UE receives RRC signaling from the base station indicating a mapping relationship of Kₛ resources to the resource groups. For example, each of Kₛ resources is indicated with a group ID (e.g., 0≤group ID≤P−1). The terminal device may determine which group the resource is in based on the group ID corresponding to the resource.

Optionally, the UE receives RRC signaling from the base station indicating (e.g., explicitly indicating, or directly indicating) P. P may also be predefined (e.g., P=1 or 2 or 3 or 4), or P is based on UE capability (e.g., P is indicated by the reported UE capability signaling). Optionally, the number of resources (N_{group}) included in each of P resource groups is determined based on P and Kₛ. For example, N_{group}=Kₛ/P, or N_{group} is determined based on ┌Kₛ/P┘. For example, each group of the first P−1 groups includes ┌Kₛ/P┘ resources; the number of resources included in the last group is Kₛ−(P−1)*┌Kₛ/P┘. For this method, the resources included in P resource groups can be based on the order of Kₛ resources. The order is e.g., the order of Kₛ resources in a resource set/in the indication signaling/in RRC signaling. For example, the first Kₛ/P resources of Kₛ resources are in the first resource group; the following Kₛ/P resources are in the second resource group; and so on. The order is, for example, the order of the (configured) resource IDs of Kₛ resources (e.g., ascending or descending order of resource IDs). For example, the first Kₛ/P resources of Kₛ resources having the smallest resource ID are in the first resource group; the following Kₛ/P resources with the smallest resource ID are in the second resource group; and so on.

Another determination method for P resource groups is described below. The method can determine measurement occasions corresponding to a plurality of slots in the time domain by configuration of a plurality of resource groups, whereby CSI parameter information related to the time domain may be provided accordingly through report of CSI corresponding to each resource group, so as for the base station for prediction to improve the performance of the communication system.

Optionally, the CSI report configuration includes/is configured with information of P resource groups. For example, the CSI report configuration corresponds to P resource groups (for channel measurement). Optionally, the number of resources included in each resource group is the same. For example, each resource group includes Kₛ resources. Optionally, the sum of the number of resources of P resource groups is P*Kₛ. In the method, it may be assumed that the first resource corresponds to/includes P resource groups, or that the first resource includes P*Kₛ resources. Optionally, each resource group may correspond to an aperiodic triggering offset parameter (e.g., aperiodicTriggeringOffset). Optionally, values of the aperiodic triggering offset parameter (e.g., aperiodicTriggeringOffset) corresponding to P resource groups (respectively) are different. Here, the aperiodic triggering offset parameter may be used to determine the reference slot (e.g., the slot where a CSI-RS is transmitted) corresponding to each resource group. Refer above for specific determination method. Optionally, indexes of P resource groups are resource group IDs. For example, the resource group ID is a configured higher layer parameter (e.g., nzp-CSI-ResourceSetId). Optionally, indexes of P resource groups may be based on the value of the aperiodic triggering offset parameter. For example, the group index of the minimum/maximum value of the corresponding aperiodic triggering offset parameter is #1 (or, is assumed as the first group); the group index of second smallest/second largest value of the corresponding aperiodic triggering offset parameter is #2 (or, is assumed as the second group); and so on.

Another determination method for P resource groups is described below. The method may obtain P resource groups by repeating a resource group in the time domain, thereby saving the overhead of signaling and improving the performance of the communication system. In addition, the UE may also provide CSI parameter information related to the time domain through report of CSI corresponding to each resource group so as for the base station for prediction, improving performance of the communication system.

Optionally, the CSI report configuration includes/is configured with information and parameter P for a resource group. For example, the CSI report configuration corresponds to a resource group (for channel measurement). For example, the resource group includes Kₛ resources. Optionally, the UE determines P resource groups based on the parameter P. Optionally, each resource group of P resource groups has the same Kₛ resources (e.g., Kₛ resources in the resource group for channel measurement). Optionally, the time/frequency domain position (or relative time/frequency domain position) of resources in each of P resource groups within a slot (or, within a corresponding slot) is the same.

The corresponding time domain positions (for example, the slot where each of P resource groups is located) of P resource groups are described below.

Optionally, P resource groups are respectively numbered #1, #2, #3, . . . , #P. Wherein the slot of the first resource group (e.g., Resource Group #1) is determined based on the aperiodic triggering offset parameter (e.g., aperiodicTriggeringOffset) of the resource group (for channel measurement) corresponding to the CSI report configuration. The method of determining the corresponding slot (e.g., the reference slot, or the slot where the resource is located) based on the aperiodic triggering offset parameter is described above.

Optionally, P resource groups correspond to different slots, respectively. Optionally, the offset between two adjacent slots from the plurality of slots corresponding to P resource groups is equal. Optionally, the offset may be predefined. For example, the value of the offset is 0, 1, 2, 3, 4. Optionally, the offset may be based on UE capability. For example, the offset may be indicated by the (reported) UE capability. Optionally, the offset may be indicated by the base station. For example, the offset may be indicated via at least one of RRC, MAC-CE, DCI.

The determination method for measurement resources (e.g., P resource groups) or measurement occasions (e.g., P measurement occasion groups) is explained above, and how the CSI parameter is determined based on these measurement resources or measurement occasions is explained below. Here, the CSI parameter may include at least one of CRI, SSBRI, L1-RSRP (or value of L1-RSRP). For convenience of description, the term “L1-RSRP” and the term “value of L1-RSRP” may be used interchangeably.

Optionally, the UE determines and/or reports the CSI parameter based on the first resource. Optionally, the UE determines and/or reports the CSI parameter based on P measurement occasion groups (or P resource groups) corresponding to the first resource.

Below is described by taking P measurement occasion groups as an example (e.g., the CSI parameter being determined based on P measurement occasion groups is described). Optionally, the CSI parameter includes/corresponds to the CSI parameter (e.g., the value of L1-RSRP) corresponding to one (or, at least one, or each) of P measurement occasion groups. Optionally, the CSI parameter corresponding to at least one (or, each) of P measurement occasion groups is in the same/in a report. The CSI parameter corresponding to a measurement occasion group may be understood as the CSI parameter being determined based on measurement of (all) measurement occasions in the corresponding measurement occasion group.

Optionally, the CSI parameter corresponding to at least one (or, each) measurement occasion group includes/corresponds to/is associated with N_{reportRS} (N_{reportRS}≥1) values of L1-RSRP. Optionally, N_{reportRS} may represent the number of the reported resources (of the corresponding CSI parameter/value of L1-RSRP). Optionally, N_{reportRS} may represent the number of reported values of L1-RSRP. Optionally, the number of the reported resources/L1-RSRP applies to each measurement resource group. Optionally, the number of reported resources of each measurement occasion group/L1-RSRP may be separately provided (or separately configured). Optionally, N_{reportRS} may be predefined. For example, N_{reportRS} may be at least one of 1, 2, 3, 4, Kₛ. Optionally, N_{reportRS} may be determined based on UE capability signaling. For example, N_{reportRS} is indicated based on the (reported) UE capability signaling. Optionally, N_{reportRS} may be determined based on UE capability signaling. For example, N_{reportRS} may be indicated by the base station.

For example, N_{reportRS} is configured via RRC signaling (e.g., nrofReportedRS in CSI-ReportConfig). Optionally, N_{reportRS} may be indicated by MAC-CE signaling. Optionally, MAC-CE may be a signaling for triggering the CSI report corresponding to the CSI configuration information. MAC-CE includes/corresponds to an (explicit) indication of N_{reportRS}; or the triggering state indicated by MAC-CE includes/corresponds to an indication of N_{reportRS}. For example, N_{reportRS} is configured via DCI signaling. Optionally, DCI may be a signaling for triggering the CSI report corresponding to the CSI configuration information. DCI (e.g., corresponding to DCI format 0_1 or DCI format 0_2) includes/corresponds to an (explicit) indication of N_{reportRS}; or the triggering state indicated by DCI includes/corresponds to an indication of N_{reportRS}.

Optionally, the CSI parameter may include/correspond to/be associated with a (one) resource indicator corresponding to at least one (or, each) measurement occasion group. Optionally, when N_{reportRS} is equal to the number of resources included/corresponding to the first resource (e.g., N_{reportRS}=Kₛ), the CSI parameter includes/corresponds to a resource indicator (e.g., CRI or SSBRI) corresponding to at least one (or, each) measurement occasion group. Optionally, the resource indicator indicates the resource corresponding to the largest measured value of L1-RSRP in the measurement occasion group determined based on a group indicator (refer below for the description of the group indicator). Optionally, the resource indicator (e.g., P resource indicators) indicates the resource in each measurement occasion group corresponding to the largest measured value of L1-RSRP.

Optionally, the CSI parameter may include/correspond to/be associated with N_{reportRS} first resource indicators corresponding to at least one (or, each) measurement occasion group. Here, the first resource indicator is used to indicate/represent the reported/measured resource; or the first resource indicator is used to indicate/represent the reported/measured resource corresponding to the (corresponding) measurement occasion group. Optionally, the CSI parameter may include N_{reportRS} resource indicators (e.g., CRI or SSBRI) corresponding to at least one (or, each) measurement occasion group when a first condition associated with N_{reportRS} and Kₛ is satisfied (e.g., N_{reportRS} is less than or equal to Kₛ/2, or N_{reportRS} is less than or equal to round up or round down of Kₛ/2, or, N_{reportRS} is less than Kₛ). N_{reportRS} resource indicators represent the resources corresponding to the (reported) value of L1-RSRP; or Kₛ−N_{reportRS} resource indicators indicate resources (for L1-RSRP measurement) that are not reported. Optionally, Kₛ in the above equation may be replaced by Kₛ+1. For example, Kₛ/2 may be replaced by

$$\frac{{K}_{s} + 1}{2} .$$

A benefit of the method is that the number of resource indicators included in the CSI parameter can be reduced, thereby reducing the overhead of CSI report and improving the efficiency of the communication system.

Optionally, the CSI parameter may include/correspond to/be associated with Kₛ−N_{reportRS} second resource indicators corresponding to at least one (or, each) measurement occasion group. Here, the second resource indicator is used to indicate/represent a resource that is not reported/not measured; or the second resource indicator is used to indicate/represent the resource corresponding to the (corresponding) measurement occasion group that is not reported/not measured. Optionally, the CSI parameter may include Kₛ−N_{reportRS} resource indicators (e.g., CRI or SSBRI) corresponding to at least one (or, each) measurement occasion group when a second condition associated with N_{reportRS} and Kₛ is satisfied (e.g., N_{reportRS} is greater than or equal to Kₛ/2, or N_{reportRS} is greater than or equal to round up or round down of Kₛ/2, and/or N_{reportRS}<Kₛ, or N_{reportRS}=Kₛ). Kₛ−N_{reportRS} resource indicators represent resources (for L1-RSRP measurement) (corresponding to each measurement occasion group) that are not reported/not measured; or Kₛ−N_{reportRS} resource indicators indicate resources (for L1-RSRP measurement) that are not reported. Optionally, Kₛ in the above equation may be replaced by Kₛ+1. For example, Kₛ/2 may be replaced by

$$\frac{{K}_{s} + 1}{2} .$$

Optionally, Kₛ/2 in the above equation may be replaced by

$$\frac{P * {K}_{s} + 1}{2 P} .$$

A benefit of the method is that the number of resource indicators included in the CSI parameter can be reduced, thereby reducing the overhead of CSI report and improving the efficiency of the communication system.

Optionally, P measurement occasion groups may share the same resource indicator. For example, the UE may select a specific subset (e.g., N_{reportRS} resources) of the resources from Kₛ resources, which is applicable to all/each measurement occasion group. Thus, for P measurement occasion groups, the number/total number of resource indicators included in/corresponding to the CSI parameter may be N_{reportRS} or Kₛ−N_{reportRS}. Optionally, P measurement occasion groups may each have a respective resource indicator. For example, for each measurement resource group, the UE may select a specific subset of the resources from Kₛ resources, which is applicable to the measurement occasion group. Thus, for P measurement occasion groups, the number/total number of resource indicators included in/corresponding to the CSI parameter may be P*N_{reportRS} or P*(Kₛ−N_{reportRS}).

Optionally, (the CSI report corresponding to) the CSI report configuration corresponds/uses differential L1-RSRP based reporting. Optionally, the CSI parameter may include/correspond to one or more values of L1-RSRP. Optionally, the values of L1-RSRP of the one or more values of L1-RSRPs other than the largest measurement value are with reference to the largest measurement value. Optionally, the largest measured value of L1-RSRP may be quantized to a 7-bit value in the range [−140, −44] dBm with 1 dB step size. Optionally, the differential L1-RSRP may be quantized to a 4-bit value. Optionally, the value of the differential L1-RSRP is computed with 2 dB step size with reference to the largest measured value of L1-RSRP. Optionally, the largest measured value of L1-RSRP is part of the same L1-RSRP reporting instance. Optionally, the largest measured value of L1-RSRP corresponds to the same measurement occasion group as the differential value of L1-RSRP.

The following method is to determine the measurement occasion group corresponding to the largest measured value of L1-RSRP and the corresponding resource, so as to further determine other differential values of L1-RSRP based on the largest measured value of L1-RSRP, so that the UE and the network device have the same understanding of L1-RSRP, improving the reliability of the communication system. Optionally, the CSI parameter may include/correspond to a group indicator and/or a corresponding resource indicator. Optionally, the group indicator is used to indicate/represent the measurement occasion group where the largest measured value of L1-RSRP is located. Optionally, the CSI parameter may include/correspond to the group indicator when the largest measured value of L1-RSRP is in the same L1-RSRP reporting as the differential value of L1-RSRP. Optionally, the bitwidth (of a CSI field) corresponding to the CSI parameter (e.g., the group indicator parameter) is determined based on the number (e.g., P) of measurement occasion groups.

For example, the group indicator parameter corresponds to the CSI field having a bitwidth of ┌log₂ P┘. Optionally, the CSI parameter may include/correspond to the resource indicator corresponding to the group indicator. Optionally, when the second condition is satisfied, the CSI parameter may include/correspond to the resource indicator corresponding to the group indicator. Optionally, the resource indicator is used to indicate the resource corresponding to the largest measured value of L1-RSRP associated with/corresponding to the measurement occasion group corresponding to the group indicator. Optionally, the resource in the measurement occasion group indicated by the group indicator corresponding to the largest measured value of L1-RSRP may be indicated by the first/last (or lowest/highest numbered) of N_{reportRS} (reported) first resource indicators. Optionally, when the first condition is satisfied, the largest measured value of L1-RSRP in the measurement resource group indicated by the group indicator may be/may correspond to the measured value of L1-RSRP corresponding to the first/last (or lowest/highest numbered) of N_{reportRS} first resource indicators. Optionally, other than the above-described L1-RSRP determined by the group indicator and the corresponding resource indicator, other L1-RSRPs (e.g., of other P−1 measurement occasion groups) are differential L1-RSRPs.

For example, when P=3, Kₛ=3, N_{reportRS}=2, L1-RSRPs corresponding to three measurement occasion groups are {L1-RSRP #1, L1-RSRP #2}, {L1-RSRP #3, L1-RSRP #4}, {L1-RSRP #5, L1-RSRP #6}, respectively. When the group indicator indicates 0 (e.g., the first group) and the resource indicator indicates the first resource, the first L1-RSRP (e.g., L1-RSRP #1) is a 7-bit quantized value (the largest measured value of L1-RSRP), L1-RSRP #2, L1-RSRP #3, L1-RSRP #4, L1-RSRP #5, L1-RSRP #6 are all 4-bit quantized values with reference to L1-RSRP #1. Optionally, the CSI parameter may include a resource indicator (e.g., CRI or SSBRI) of one (or, at least, one, or each) measurement occasion group. Optionally, the resource indicator is used to represent the resource in the corresponding measurement occasion group corresponding to the largest measured value of L1-RSRP.

For example, the CSI parameter may include a resource indicator of one (or at least one, or each) measurement occasion group (respectively) for representing/indicating the largest measured value of L1-RSRP of the corresponding measurement occasion group. Optionally, the resource in at least one (or, each) measurement occasion group corresponding to the largest measured value of L1-RSRP may be indicated by the first/last (or, lowest/highest numbered) in N_{reportRS} (reported) first resource indicators. For example, when P=3, Kₛ=2, N_{reportRS}=2, L1-RSRPs corresponding to three measurement occasion groups are {L1-RSRP #1, L1-RSRP #2}, {L1-RSRP #3, L1-RSRP #4}, {L1-RSRP #5, L1-RSRP #6}, respectively, and each group indicates the first resource, the second resource, the first resource, respectively. Here, L1-RSRP #1, L1-RSRP #4, L1-RSRP #5 are 7-bit quantized values. L1-RSRP #2, L1-RSRP #3, L1-RSRP #6 are 4-bit quantized values with reference to L1-RSRP #1, L1-RSRP #4, L1-RSRP #5, respectively.

Optionally, (the order of) the CSI parameter is determined based on at least one of: an order of P measurement occasion groups, an order of the CSI parameter. Optionally, the order of the CSI parameter refers to the order of the information bits corresponding to the CSI parameter (or, the sequential order of the information bits). Here, the order of P measurement occasion groups may be the order of the measurement occasion groups corresponding to the CSI parameter.

Optionally, the order of P measurement occasion groups may be the order of the IDs corresponding to P measurement occasion groups. For example, each measurement occasion group may be configured with an ID. The order of P measurement occasion groups may be an ascending/descending order of the configured ID of P measurement occasion groups. For example, each measurement occasion group may be assigned an ID. The order of P measurement occasion groups may be an ascending/descending order of the assigned IDs of P measurement occasion groups. Here, the group ID is assigned as described above for P measurement occasion groups. For example, the value of the ID of the first one of P measurement occasion groups is 0; the value of the ID of the second one of P measurement occasion groups is 1; and so on. For example, the value of the ID of the first one of P measurement occasion groups is 1; the value of the ID of the second one of P measurement occasion groups is 2; and so on.

Optionally, the order of P measurement occasion groups may be the order of P measurement occasion groups in the corresponding configuration signaling. For example, the first one of P measurement occasion groups represents the first configured measurement occasion group; the second one of P measurement occasion groups represents the second configured measurement occasion group; and so on.

Optionally, the order of CSI parameter may be an order of the types of the CSI parameter. Here, the types of the CSI parameter may include the value of L1-RSRP and CRI (and/or the group indicator), or the value of L1-RSRP and SSBRI (and/or the group indicator). When the types of the CSI parameter include the value of L1-RSRP and CRI, the (sequential) order of the types of the CSI parameter are CRI, the value of L1-RSRP. When the types of the CSI parameter include the value of L1-RSRP and SSBRI, the (sequential) order of the types of the CSI parameter are SSBRI, the value of L1-RSRP. When the types of the CSI parameter include the value of L1-RSRP and CRI and the group indicator, the (sequential) order of the types of the CSI parameter are the group indicator, CRI, the value of L1-RSRP; or, a CRI, the value of L1-RSRP, the group indicator. When the types of the CSI parameter include the value of L1-RSRP and SSBRI and the group indicator, the (sequential) order of the types of the CSI parameter are the group indicator, SSBRI, the value of L1-RSRP, or SSBRI, the value of L1-RSRP, the group indicator. The sequential order here is exemplary and the sequential order of the types may be interchangeable.

Optionally, the order of the CSI parameter may be the order of the quantization corresponding to the CSI parameter (e.g., L1-RSRP). Here, the quantization may include non-differential quantization and differential quantization. Optionally, the non-differential quantization may be referred as absolute quantization (e.g., the quantization corresponding to the largest measured value of L1-RSRP described above). Optionally, the differential quantization represents the quantization that is with reference to other measured values/quantized values (the difference value is quantized) (e.g., the quantization that is with reference to the largest measured value of L1-RSRP described above). Optionally, the (sequential) order of the quantization corresponding to the CSI parameter (e.g., L1-RSRP) may be: the non-differential quantization, the differential quantization; or, the differential quantization, the non-differential quantization.

Optionally, the order of the CSI parameter may be the order of indexes corresponding to the CSI parameter (e.g., L1-RSRP). Optionally, based on the number of reported CSI parameter (the value of L1-RSRP/CRI/SSBRI), the CSI parameter may be numbered accordingly (in order). For example, when N_{reportRS} CRIs are reported, they may be numbered CRI #1, CRI #2, CRI #N_{reportRS}. For example, when N_{reportRS} CRIs are reported, they may be numbered CRI #0, CRI #1, CRI #N_{reportRS}−1. Optionally, the order of the indexes corresponding to the CSI parameter may be an ascending order or a descending order of the indexes corresponding to the CSI parameter. Optionally, the largest measured value of L1-RSRP and/or the CRI/SSBRI corresponding to the largest measured value of L1-RSRP may correspond to the first index. Optionally, in the measurement occasion group indicated by the group indicator, the largest measured value of L1-RSRP and/or the CRI/SSBRI corresponding to the largest measured value of L1-RSRP may correspond to the first index.

Optionally, the CSI parameter may be first based on the order of the CSI parameter and then based on the order of P measurement occasion groups. The sequential order here is exemplary and their sequential order may be interchangeable.

Optionally, the CSI parameter may be first based on the order of the types of the CSI parameter, then based on the quantization corresponding to the CSI parameter, then based on the order of P measurement occasion groups, and then based on the order of CSI parameter indexes. The sequential order here is exemplary and their sequential order may be interchangeable.

The CSI parameter determined based on P resource groups are described below in the case where the reference signal resource (e.g., one or more reference signal resources included in the first resource) is aperiodic, periodic, or semi-persistent, taking P resource groups as an example. Optionally, the CSI parameter includes/corresponds to the CSI parameter (e.g., the value of L1-RSRP) corresponding to one (or, at least one, or each) of P resource groups. Optionally, the CSI parameter corresponding to at least one (or each) of P resource groups is in the same/in a report. A CSI parameter corresponding to a resource group may be understood as being determined based on measurement of (all) the resource in the corresponding resource group. Optionally, the CSI parameter corresponding to at least one (or, each) resource group includes/corresponds to/is associated with N_{reportRS} (N_{reportRS}≥1) values of L1-RSRP. Optionally, N_{reportRS} may represent the number of resources (of the corresponding CSI parameter/value of L1-RSRP) that are reported/not reported. Optionally, N_{reportRS} may represent the number of resources (of the corresponding CSI parameter/value of L1-RSRP) that are reported/not reported per resource group. Optionally, Refer the above for the determination method for N_{reportR}.

Optionally, the CSI parameter may include/correspond to/be associated with a (one) resource indicator corresponding to at least one (or, each) resource group. Optionally, when N_{reportRS} is equal to the number of resources in the resource group included in/corresponding to the first resource (e.g., N_{reportRS}=N_{group}), the CSI parameter includes/corresponds to a resource indicator (e.g., CRI or SSBRI) corresponding to at least one (or, each) resource group. Optionally, the resource indicator indicates the resource corresponding to the largest measured value of L1-RSRP in the resource group determined based on the group indicator (refer below for the description of the group indicator). Optionally, the resource indicators (e.g., P resource indicators) indicate the resource in each resource group corresponding to the largest measured value of L1-RSRP.

Optionally, the CSI parameter may include/correspond to/be associated with N_{reportRS} first resource indicators corresponding to at least one (or, each) resource group. Here, the first resource indicator is used to indicate/represent the reported/measured resource; or the first resource indicator is used to indicate/represent the reported/measured resource corresponding to the (corresponding) resource group. Optionally, the CSI parameter may include N_{reportRS} resource indicators (e.g., CRI or SSBRI) corresponding to at least one (or, each) resource group when a first condition associated with N_{reportRS} and N_{group} is satisfied (e.g., N_{reportRS} is less than or equal to N_{group}/2, or N_{reportRS} is less than or equal to round up or round down of N_{group}/2, or, N_{reportRS} is less than N_{group}). N_{reportRS} resource indicators represent the resource corresponding to the (reported) value of L1-RSRP; or N_{group}-N_{reportRS} resource indicators indicate the resource (for L1-RSRP measurement) that is not reported. Optionally, N_{group} in the above equation may be replaced by N_{group}+1. For example, N_{group}/2 may be replaced by

$$\frac{{N}_{group} + 1}{2} .$$

A benefit of the method is that the number of resource indicators included in the CSI parameter can be reduced, thereby reducing the overhead of CSI report and improving the efficiency of the communication system.

Optionally, the CSI parameter may include/correspond to/be associated with N_{group}−N_{reportRS} second resource indicators corresponding to at least one (or, each) resource group. Here, the second resource indicator is used to indicate/represent the resource that is not reported/not measured; or the second resource indicator is used to indicate/represent the resource corresponding to the (corresponding) resource group that is not reported/not measured. Optionally, when a second condition associated with N_{reportRS} and N_{group} is satisfied (e.g., N_{reportRS} is greater than or equal to N_{group}/2, or N_{reportRS} is greater than or equal to round up or round down of N_{group}/2, and/or N_{reportRS}<N_{group}, or N_{reportRS}=N_{group}), the CSI parameter may include N_{group}−N_{reportRS} resource indicators (e.g., CRI or SSBRI) corresponding at least one (or each) resource group. N_{group}−N_{reportRS} resource indicators represent the resource (for L1-RSRP measurement) (corresponding to each resource group) that is not reported/not measured; or N_{group}-N_{reportRS} resource indicators indicate the resource (for L1-RSRP measurement) that is not reported. Optionally, N_{group} in the above equation may be replaced by N_{group}+1. For example, N_{group}/2 may be replaced by

$$\frac{{N}_{group} + 1}{2} .$$

Optionally, N_{group}/2 in the above equation may be replaced by

$$\frac{P * {N}_{group} + 1}{2 P} .$$

A benefit of the method is that the number of resource indicators included in the CSI parameter can be reduced, thereby reducing the overhead of CSI report and improving the efficiency of the communication system.

Optionally, P resource groups may share the same resource indicator. For example, the UE may select a specific subset of the resource (e.g., N_{reportRS} resources) from N_{group} resources, which is applicable to all/each resource group. Thus, for P resource groups, the number/total number of resource indicators included in/corresponding to the CSI parameter may be N_{reportRS} or N_{group}−N_{reportRS}. Optionally, P resource groups may each have a respective resource indicator. For example, for each measurement resource group, the UE may select a specific subset of the resource from N_{group} resources, which is applicable to the resource group. Thus, for P resource groups, the number/total number of resource indicators included in/corresponding to the CSI parameter may be P*N_{reportRS} or P*(N_{group}−N_{reportRS}).

Optionally, the CSI parameter corresponding to at least one (or, each) of P resource groups is determined based on the number of the resource in the corresponding resource group. Optionally, the bitwidth (of the CSI field) corresponding to the CSI parameter (e.g., CRI or SSBRI) is determined based on the number (e.g., N_{group}) in one (or, each) resource group. For example, the bitwidth of the (CSI field of the) CRI or SSBRI corresponding to a resource group is ┌log₂ N_{group}┘. A benefit of doing so is that respective resources can be grouped to indicate, reducing the number of bits corresponding to the resource indication, saving signaling overhead and improving the efficiency of the communication system. Optionally, the bitwidth (of the CSI field) corresponding to the CSI parameter (e.g., CRI or SSBRI) is determined based on the number (e.g., Kₛ) of the resource corresponding to the first resource. For example, the corresponding bitwidth (of the CSI field) of the CSI parameter is ┌log₂ Kₛ┘. Refer above for the description for Kₛ and N_{group} (optionally, the determination method).

Optionally, (the CSI report corresponding to) the CSI report configuration corresponds/uses differential L1-RSRP based reporting. Optionally, the CSI parameter may include/correspond to one or more values of L1-RSRP. Optionally, the values of L1-RSRP of the one or more values of L1-RSRPs other than the largest measurement value are with reference to the largest measurement value. Optionally, the largest measured value of L1-RSRP may be quantized to a 7-bit value in the range [−140, −44] dBm with 1 dB step size. Optionally, the differential L1-RSRP may be quantized to a 4-bit value. Optionally, the value of the differential L1-RSRP is computed with 2 dB step size with reference to the largest measured value of L1-RSRP. Optionally, the largest measured value of L1-RSRP is part of the same L1-RSRP reporting instance. Optionally, the largest measured value of L1-RSRP corresponds to the same resource group as the differential value of L1-RSRP.

The following method is to determine the resource group corresponding to the largest measured value of L1-RSRP and the corresponding resource, so as to further determine other differential values of L1-RSRP based on the largest measured value of L1-RSRP, so that the UE and the network device have the same understanding of L1-RSRP, improving the reliability of the communication system. Optionally, the CSI parameter may include/correspond to a group indicator and/or a corresponding resource indicator. Optionally, the group indicator is used to indicate/represent the resource group where the largest measured value of L1-RSRP is located. Optionally, when the largest measured value of L1-RSRP is in the same L1-RSRP reporting as the differential value of L1-RSRP, the CSI parameter may include/correspond to the group indicator. Optionally, the bitwidth (of the CSI field) corresponding to the CSI parameter (e.g., the group indicator parameter) is determined based on the number (e.g., P) of resource groups.

For example, the group indicator parameter corresponds to the CSI field having a bitwidth of ┌log₂ P┘. Optionally, the CSI parameter may include/correspond to the resource indicator corresponding to the group indicator. Optionally, when the second condition is satisfied, the CSI parameter may include/correspond to the resource indicator corresponding to the group indicator. Optionally, the resource indicator is used to indicate the resource corresponding to the largest measured value of L1-RSRP associated with/corresponding to the resource group corresponding to the group indicator. Optionally, the resource in the resource group indicated by the group indicator corresponding to the largest measured value of L1-RSRP may be indicated by the first/last (or lowest/highest numbered) of N_{reportRS} (reported) first resource indicators. Optionally, when the first condition is satisfied, the largest measured value of L1-RSRP in the measurement resource group indicated by the group indicator may be/may correspond to the measured value of L1-RSRP corresponding to the first/last (or lowest/highest numbered) of N_{reportRS} first resource indicators. Optionally, other than the above-described L1-RSRP determined by the group indicator and the corresponding resource indicator, other L1-RSRPs (e.g., of other P−1 resource groups) are differential L1-RSRPs.

For example, when P=3, Kₛ=3, N_{reportRS}=2, L1-RSRPs corresponding to three resource groups are {L1-RSRP #1, L1-RSRP #2}, {L1-RSRP #3, L1-RSRP #4}, {L1-RSRP #5, L1-RSRP #6}, respectively. When the group indicator indicates 0 (e.g., the first group) and the resource indicator indicates the first resource, the first L1-RSRP (e.g., L1-RSRP #1) is a 7-bit quantized value (the largest measured value of L1-RSRP), L1-RSRP #2, L1-RSRP #3, L1-RSRP #4, L1-RSRP #5, L1-RSRP #6 are all 4-bit quantized values with reference to L1-RSRP #1. Optionally, the CSI parameter may include a resource indicator (e.g., CRI or SSBRI) of one (or, at least, one, or each) resource group. Optionally, the resource indicator is used to represent the resource in the corresponding resource group corresponding to the largest measured value of L1-RSRP. For example, the CSI parameter may include a resource indicator of one (or at least one, or each) resource group (respectively) for representing/indicating the largest measured value of L1-RSRP of the corresponding resource group. Optionally, the resource in at least one (or, each) resource group corresponding to the largest measured value of L1-RSRP may be indicated by the first/last (or, lowest/highest numbered) in N_{reportRS} (reported) first resource indicators.

For example, when P=3, Kₛ=2, N_{reportRS}=2, L1-RSRPs corresponding to three resource groups are {L1-RSRP #1, L1-RSRP #2}, {L1-RSRP #3, L1-RSRP #4}, {L1-RSRP #5, L1-RSRP #6}, respectively, and each group indicates the first resource, the second resource, the first resource, respectively. Here, L1-RSRP #1, L1-RSRP #4, L1-RSRP #5 are 7-bit quantized values. L1-RSRP #2, L1-RSRP #3, L1-RSRP #6 are 4-bit quantized values with reference to L1-RSRP #1, L1-RSRP #4, L1-RSRP #5, respectively.

Optionally, (the order of) the CSI parameter is determined based on at least one of: an order of P resource groups, an order of the CSI parameter. Optionally, the order of the CSI parameter refers to the order of the information bits corresponding to the CSI parameter (or, the sequential order of the information bits). Here, the order of P resource groups may be the order of the resource groups corresponding to the CSI parameter. Refer above for the determination method of (the order of) the CSI parameter being based on the order of P resource groups and/or the order of the CSI parameter, wherein the “measurement occasion group” in the method may be replaced by the “resource group.”

Optionally, (for L1-RSRP computation and/or when the first resource corresponds to the CSI-RS resource) the UE may determine/assume that all the resource corresponding to the first resource (or P resource measurement occasion groups corresponding to the first resource, or P resource groups corresponding to the first resource) have the same energy per resource element (EPRE) (or have the same value of powerControlOffsetSS).

Optionally, (for L1-RSRP computation and/or when the first resource corresponds to the CSI-RS resource) all the resource corresponding to the first resource (or P resource measurement occasion groups corresponding to the first resource, or P resource groups corresponding to the first resource) have the same EPRE (or have the same value of powerControlOffsetSS). Here, powerControlOffsetSS represents a power offset of NZP CSI-RS RE to secondary synchronization signal (SSS) resource element (RE).

Optionally, (for L1-RSRP computation and/or when the first resource corresponds to the CSI-RS resource) all resources corresponding to at least one of P resource measurement occasion groups corresponding to the first resource (or at least one of P resource groups corresponding to the first resource) have the same EPRE (or have the same value of powerControlOffsetSS).

Optionally, (for L1-RSRP computation and/or when the first resource corresponds to the CSI-RS resource and/or when the first resource is aperiodic resource) the resource (e.g., N_{group} resources) in a resource group (or each resource group) of P resource groups corresponding to the first resource:
optionally, N_{group} resources are in the same slot;
optionally, the slot/symbol offsets of the N_{group} resources are configured within X slots/symbol. Optionally, X may be predefined or determined based on UE capability. For example, X is indicated by the reported UE capability parameter. X may be one of 1, 2, 3 and 4;
optionally, N_{group} resources are (configured) within X adjacent/consecutive slots. Optionally, X may be predefined or determined based on UE capability. For example, X is indicated by the reported UE capability parameter. X may be one of 1, 2, 3 and 4. Optionally, X>1;
optionally, N_{group} resources are (configured) within the same slot or adjacent slots;
optionally, N_{group} resources are in the same symbols. Optionally, N_{group} resources occupy the same symbol, for example, the starting symbol/first symbol/ending symbol of N_{group} resources are in the same symbol. For example, the parameters firstOFDMSymbolInTimeDomain and/or the parameters of firstOFDMSymbolInTimeDomain2 of (each resource in) K_predicted resources are the same. Optionally, the symbols occupied by (each resource in) the resource in one and/or each of P groups are partially the same or completely the same;
optionally, N_{group} resources are without DL/UL switching in between (any of) two resources;
optionally, the bandwidths and/or subcarriers corresponding to/associated with/occupied by N_{group} resources are the same;
optionally, the physical resource blocks (PRB) corresponding to/associated with/occupied by N_{group} resources are the same or are adjacent; and/or
optionally, the energy per resource element (EPRE) corresponding to/associated with/occupied by N_{group} resources is the same.

The above restrictions to N_{group} resources may ensure phase continuity between the measurements of N_{group} resources, improve the accuracy of the CSI, and further improve the reliability of the communication system.

Optionally, the UE assume/determine that antenna port with the same port index of the y-th resource in each of P groups is the same. Optionally, y=1, 2, . . . , N_{group}. Optionally, the y-th resource in a group is determined based on the order (e.g., ascending/descending) of resource IDs. For example, the y-th resource in a group is the resource with the y-th smallest/y-th largest resource ID in the group. Optionally, the y-th resource in a group is determined based on the order (for example, ascending/descending) in the resource set configuration information associated with the resource. For example, the y-th resource in a group is the y-th resources in ascending/descending order of the configuration information associated with/corresponding to the resource in the group in the configuration information associated with/corresponding to the first resource.

For example, the first resource in a group is the first resource of the configuration information associated with/corresponding to the resource in the group in the configuration information associated with/corresponding to the first resource. Optionally, the UE performs measurement and/or CSI computation based on the assumption that antenna ports with same port index of the y-th resource in each of P groups are of same antenna ports. Optionally, the UE assumes/determines that antenna port with the same port index (used for CSI computation) of the y-th resource in each of P groups is the same antenna port. Optionally, the UE performs measurement and/or CSI computation based on the assumption that antenna port with the same port index (used for CSI computation) of the y-th resource in each of P groups is the same antenna port. Optionally, the CSI computation may be CSI prediction. Optionally, the CSI computation is, for example, the computation of CRI and/or SSBRI and/or precoding index.

For example, the UE assumes that the antenna port with the index of 3000 of the first CSI-RS in group #1 and the antenna port with the index of 3000 of the first CSI-RS in group #2 are the same antenna ports. Assuming that the ports of multiple reference signals have the same antenna port index, it is convenient for the UE to jointly estimate the channel of these antenna ports (in different slots), so as to predict the CSI in time domain and improve the performance of CSI feedback.

Optionally, the y-th resource of each of P groups has (or is configured or indicated) the same QCL parameter/QCL assumption. Optionally, the UE assumes/determines that the y-th resource of each of P groups has (or is configured or indicated) the same QCL parameter/QCL assumption. Optionally, the QCL parameter may be a QCL type A parameter and/or a QCL type D parameter. Optionally, y=1, 2, . . . , N_{group}. Optionally, the UE performs measurement and/or CSI computation based on the assumption that the y-th resource of each of the P groups has (or is configured or indicated) the same QCL parameter. Optionally, the CSI computation may be CSI prediction. Optionally, the CSI computation may be beam prediction. Optionally, the CSI computation is, for example, the computation of CRI and/or SSBRI and/or beam indicator. For example, the QCL parameter of the first CSI-RS in group #1 is the same as that of the first CSI-RS in group #2. For example, UE assumes that the QCL parameter of the first CSI-RS in group #2 is the same as that of the first CSI-RS in group #3. The QCL parameters of multiple reference signals being the same (or the QCL of multiple reference signals being assumed to be the same) may facilitate the UE to jointly measure these reference signals (in different slots), so as to predict CSI in time domain and improve the performance of CSI feedback.

Optionally, the CSI report configuration information is associated with/corresponds to/includes one or more first sub-configurations. Here, the sub-configuration may be referred as sub-configuration information. Optionally, the first sub-configuration may be sub-configuration information of the CSI report.

Optionally, a second sub-configuration includes one or more of the first sub-configurations. Optionally, the second sub-configuration is (for example, one of, or any of, or each or all of) sub-configuration(s) from a plurality of first sub-configurations. For example, if the information for the CSI report configuration corresponds to periodic CSI report, the second sub-configuration is (for example, one of, or any of, or each of) one or more first sub-configurations.

Optionally, when the information for the CSI report configuration corresponds to periodic CSI report, each reporting instance of the periodic CSI report is for all sub-configurations in one or more first sub-configurations. For example, the number of the one or more first sub-configurations may be L, where L>1 (or L>=1).

For example, the number of the one or more first sub-configurations may be L, where L>1 (or L>=1). For example, where the second sub-configurations are all sub-configurations in a subset of the one or more first sub-configurations, the number of the second sub-configuration may be N, where N<=L and/or N>=1. Optionally, in the case that the CSI report is periodic CSI report, N=L. For example, the CSI report includes a CSI parameter corresponding to all sub-configurations in the one or more first sub-configurations. Optionally, the CSI report corresponding to periodic CSI report, refers to report type parameter (e.g., reportConfigType) in the information for the CSI report configuration (for example, CSI-ReportConfig) is set to “periodic.”

Optionally, the second sub-configuration(s) includes a subset of the one or more first sub-configurations. Optionally, the second sub-configuration is (for example, one of, or any of, or each or all of) a subset of the one or more first sub-configurations. For example, when the information for the CSI report configuration corresponds to semi-persistent CSI report or aperiodic CSI report, the second sub-configuration(s) may be (for example, one of, or any of, or each or all of) a subset of the one or more first sub-configurations. For example, the number of the one or more first sub-configurations may be L, where L>1 (or L>=1). For example, taking an example that the second sub-configuration(s) are all sub-configurations in a subset of the one or more first sub-configurations, the number of the second sub-configuration(s) may be N, where N<=L and/or N>=1. Optionally, the subset is indicated (or provided) by a signaling that triggers/activates/schedules/indicate a CSI report that corresponds to the information for the CSI report configuration. For example, if the CSI report configuration includes (or, is configured with) L sub-configuration(s), a signaling may trigger/activate/schedule/indicate CSI report that corresponds to the information for the CSI report configuration, and the signaling may indicate N sub-configuration(s) in the L sub-configuration(s) for the CSI report.

For example, UE generates/derives CSI (for example, a CSI parameter) corresponding to the N sub-configuration(s) in the L sub-configuration(s) and includes them into the CSI report. For example, if the information for the CSI report configuration corresponds to semi-persistent CSI report on physical uplink control channel (PUCCH), and the information for the CSI report configuration includes (or, is configured with) L sub-configuration(s), then a media access control-control element (MAC-CE) signaling may trigger a CSI report corresponding to the CSI report configuration (for example, the CSI report is carried by the PUCCH), and the MAC-CE signaling may include indication information for indicating N sub-configuration(s) from the L sub-configuration(s) for the CSI report.

For example, if the information for the CSI report configuration corresponds to a semi-persistent CSI report on a physical uplink shared channel (PUSCH), and the information for the CSI report configuration includes (or, is configured with) L sub-configuration(s), then downlink control information (DCI) (or a DCI format) may trigger a CSI report corresponding to the CSI report configuration (for example, the CSI report is carried by the PUSCH), and the DCI may indicate a triggering state. Optionally, the triggering state is associated with N sub-configuration(s) (in the L sub-configurations) (optionally, the triggering state may indicate N configuration(s)) for the CSI report. Optionally, the DCI format may be a DCI format 0_1 or a DCI format 0_2. For example, if the information for the CSI report configuration corresponds to aperiodic CSI report, and the information for the CSI report configuration includes (or, is configured with) L sub-configuration(s), then downlink control information (DCI) (or a DCI format) may trigger a CSI report corresponding to the CSI report configuration (for example, the CSI report is carried by a PUSCH), and the DCI may indicate a triggering state.

Optionally, the triggering state is associated with N sub-configurations (in the L sub-configurations) (optionally, the triggering state indicates N configuration(s)) for the CSI report. Optionally, the DCI format may be DCI format 0_1 or DCI format 0_2. Optionally, the information for the CSI report configuration corresponding to a semi-persistent CSI report on a PUCCH, means that a report type parameter (reportConfigType) in the information for the CSI report configuration (for example, CSI-ReportConfig) is set to “a semi-persistent report on a PUCCH” (semiPersistentOnPUCCH). Optionally, the information for the CSI report configuration corresponding to semi-persistent CSI report on PUSCH, means that a report type parameter (reportConfigType) in the information for the CSI report configuration (for example, CSI-ReportConfig) is set to “a semi-persistent report on PUSCH” (semiPersistentOnPUSCH). Optionally, the information for the CSI report configuration corresponding to aperiodic CSI report, means that a report type parameter (reportConfigType) in the information for the CSI report configuration (for example, CSI-ReportConfig) is set to “aperiodic.” Optionally, the description of the second sub-configuration(s) in the disclosure may be applicable to one sub-configuration of, or each sub-configuration of, or any sub-configuration of, one or more first sub-configurations. Optionally, the description of the second sub-configuration(s) in the disclosure may apply to one sub-configuration of, or each sub-configuration of, or any sub-configuration of, a subset of one or more first sub-configuration(s). Optionally, in the disclosure, second sub-configuration(s) may be equivalent to one or more first sub-configuration(s). Optionally, in the disclosure, second sub-configuration(s) may be equivalent to first sub-configuration(s).

Optionally, the UE determines CSI parameter based on the second sub-configuration(s). As used herein, the term “CSI parameter” may be used interchangeably with the term “parameter for the CSI report.” Optionally, the determining CSI parameter may be computing CSI parameter. Optionally, the determining a CSI parameter may be determining CSI feedback. The determining CSI parameter may also be determining a report that carries CSI parameter (that is, determining CSI report). Optionally, the CSI parameter may be CSI feedback. The CSI parameter may also be a report that carries the CSI parameter (that is, CSI report).

Optionally, CSI parameter may be at least one of CSI-RS resource indicator (CRI), rank indicator (RI), precoding matrix indicator (PMI), channel quality indicator (CQI), layer indicator (LI). Optionally, the CSI parameter may be at least one of a CSI-RS resource indicator (CRI), SS/PBCH block resource indicator (SSBRI), Layer 1-reference signal receive power (L1-RSRP), Layer 1-signal interference-to-noise ratio (L1-SINR), and a capability index (Capability Index).

Optionally, the second sub-configuration includes/is associated with a parameter for indicating whether to report the CSI parameter (e.g., L1-RSRP). Optionally, the one or more sub-configurations corresponding to the CSI report configuration may respectively include/is associated with the parameter for indicating whether to report the CSI parameter. When one sub-configuration is indicated to report the CSI parameter (e.g., L1-RSRP), the CSI (or the CSI parameter) corresponding to the sub-configuration includes/corresponds to the respective CSI parameter (e.g., L1-RSRP). When one sub-configuration is indicated not to report the CSI parameter (e.g., L1-RSRP), the CSI (or the CSI parameter) corresponding to the sub-configuration does not include/correspond to the respective CSI parameter (e.g., L1-RSRP).

Optionally, when the UE supports the capability of time domain prediction and/or the capability of spatial domain prediction, the UE may perform the method of one or more embodiments disclosed herein.

Optionally, when the UE supports the capability of UE-side prediction, the UE may perform the method of one or more embodiments disclosed herein.

Optionally, when the UE supports the capability of (UE-side) time domain prediction and/or the capability of (UE-side) spatial domain prediction, the UE may perform the method of one or more embodiments disclosed herein.

Optionally, the term “prediction” may be interchangeable with the term “beam prediction” or “UE-side prediction” or “spatial domain prediction” or “time domain prediction” or “time domain-spatial domain prediction.”

Optionally, “resource indicator” may be interchangeable with the term “beam indicator,” and “measured L1-RSRP” may be replaced with “predicted L1-RSRP” when “beam indicator” is used instead of “resource indicator” or “CRI” or “SSBRI.”

Optionally, “CRI” may be interchangeable with the term “beam indicator.”

Optionally, “SSBRI” may be interchangeable with the term “beam indicator.”

Various embodiments of the present disclosure provide a description of the beam indicator.

The advantage of one or more embodiments disclosed herein is that the determination method for the CSI parameter being based on the measurement resource or the measurement occasion is clarified so that the UE and the base station can have the same understanding of the measurement occasion/measurement resource and the corresponding CSI parameter, improving the reliability of the communication system.

The UE receives CSI report configuration information (e.g., csi-ReportConfig). Optionally, the CSI report configuration corresponds to the first resource. Here, refer to one or more embodiments disclosed herein for the description of the first resource. Optionally, refer to one or more embodiments disclosed herein for the determination method for the time domain position of the first resource. Optionally, the CSI report configuration information corresponds to a specific report quantity. Here, refer to one or more embodiments disclosed herein for the description of the report quantity.

Optionally, the UE may determine and/or report the CSI parameter. For example, the UE determines and/or reports the CSI parameter based on the CSI report configuration information (e.g., CSI-ReportConfig). Optionally, the UE determines and/or reports the CSI parameter based on the first resource. Optionally, the UE determines and/or reports the CSI parameter based on measurement of the first resource. Optionally, the UE determines and/or reports the CSI parameter based on measurement of the resource in P groups associated with the first resource.

Optionally, the CSI parameter may include/correspond to a beam indicator and/or L1-RSRP. Optionally, the CSI parameter may be a predicted CSI parameter. Optionally, the CSI parameter may include/correspond to a predicted beam indicator and/or a predicted L1-RSRP. Optionally, the beam indicator may indicate the reference signal resource. Optionally, the beam indicator may be a resource indicator. Optionally, the beam indicator may be CRI and/or SSBRI.

Optionally, the number of information bits corresponding to the beam indicator may be determined based on Kₛ. Refer to one or more embodiments disclosed herein for the definition and description of Kₛ.

Optionally, the beam indicator (k) corresponds to the first resource. Take the number of the first resource being Kₛ as an example. Optionally, the number of information bits corresponding to the beam indicator is ┌log₂ Kₛ┘. For example, k=0 represents the first one of the first resource; k=1 represents the second one of the first resource, and so on.

Optionally, the number of information bits corresponding to the beam indicator is determined based on the number of the first resource and a parameter (deltaSetA). Here, take the number of the first resource being Kₛ as an example. Optionally, deltaSetA may represent the difference between the number of beams (or, resources) used for prediction and the number of resources (or, beams) used for measurement. Optionally, deltaSetA may represent the difference of the number of resources in the resource set used for measurement and the number of beams (or resources) in the beam set (or resource set) used for prediction. Optionally, if the UE is configured with periodic or semi-persistent CSI-RS resource (or, resource groups) for channel measurement, the UE performs the method. For example, the UE performs the method when the CSI report configuration corresponding to the periodic or semi-persistent resource (or resource groups) for channel measurement. Optionally, some of the values in the range of values of the beam indicator correspond to the resource in Kₛ resources, and another of the values in the range of values of the beam indicator are used for prediction (and/or beam prediction, and/or UE-side prediction, and/or spatial domain prediction, and/or time domain prediction).

For example, the number of information bits corresponding to the beam indicator is ┌log₂(Kₛ+deltaSetA)┘. For example, k is an integer ranging from 0 to Kₛ+deltaSetA−1. For example, when k<Kₛ, k corresponds to the resource in Kₛ resource. For example, k=0 represents the first one of the first resource; k=1 represents the second one of the first resource; . . . ; k=Kₛ−1 represents the Kₛ-th resource of the first resource. For example, when k>Kₛ, k is used for prediction. For example, k=Kₛ represents the first predicted beam; k=Kₛ+1 represents the second predicted beam; and so on. Optionally, the beam indicator may be associated with deltaSetA reference signals (e.g., aperiodic reference signals or semi-persistent reference signals), or deltaSetA SSBs.

For example, k=Kₛ represents the first reference signal or the first SSB; k=Kₛ+1 represents the second reference signal or the second SSB; and so on. Optionally, information for deltaSetA reference signals, or information for deltaSetA SSBs is indicated/configured via RRC signaling. Optionally, deltaSetA may be predefined, e.g., deltaSetA may be one of 1, 2, 3, 4, 5, 6, 7, 8. Optionally, deltaSetA may be based on UE capability. Optionally, deltaSetA may be indicated by the (reported) UE capability signaling. Optionally, deltaSetA may be indicated by the base station (e.g., via at least one of RRC, MAC-CE, DCI). Optionally, when deltaSetA is not configured, the value (or default value) of deltaSetA is 0. In the disclosure, the term “beam” may be replaced with one of the terms “spatial domain filter,” “spatial domain transmit filter,” “downlink spatial domain transmit filter,” “spatial domain filter for base station transmission,” “resource,” “reference signal resource,” “beam resource,” “transmission configuration indication (TCI) state,” “quasi co-location (QCL) parameter,” “QCL assumption.”

Optionally, the number of information bits corresponding to the beam indicator is determined based on the number of the first resource and the parameter (deltaSetA). Here, the number of the first resource is exemplified by Kₛ. Optionally, if the UE is configured with aperiodic CSI-RS resource (or resource groups) for channel measurement, the UE performs the method. For example, the UE performs the method when the CSI report configuration corresponding to the aperiodic resource group for channel measurement. Optionally, some of the values in the range of values of the beam indicator correspond to (part of) the resources in Kₛ resources, and another of the values in the range of values of the beam indicator are used for prediction (and/or beam prediction, and/or UE-side prediction, and/or spatial domain prediction, and/or time domain prediction). Optionally, the number of information bits corresponding to the beam indicator is determined based on N_{group} and the parameter (deltaSetA). Here, Kₛ resources for channel measurement may be divided into P resource groups. Refer to one or more embodiments disclosed herein for the definition of the specific implementation and N_{group}.

For example, the number of information bits corresponding to the beam indicator is ┌log₂(N_{group}+deltaSetA)┘. For example, k is an integer ranging from 0 to N_{group}+deltaSetA−1. For example, when k<N_{group}, k corresponds to the resource of one of P resource groups (e.g., the resource of the first/last/penultimate resource group). Take the resource of the first resource group as an example, k=0 represents the first resource of the first resource group; k=1 represents the second resource of the first resource group; . . . ; k=N_{group}−1 represents N_{group}-th resource of the first resource group. For example, when k>N_{group}, k is used for prediction. For example, k=N_{group} represents the first predicted beam; k=N_{group}+1 represents the second predicted beam; and so on. Optionally, the beam indicator may be associated with deltaSetA reference signals (e.g., aperiodic reference signals or semi-persistent reference signals), or deltaSetA SSBs. For example, k=Kₛ represents the first reference signal or the first SSB; k=Kₛ+1 represents the second reference signal or the second SSB; and so on. Optionally, information for deltaSetA reference signals, or information for deltaSetA SSBs is indicated/configured via RRC signaling. Optionally, deltaSetA is defined and determined as described above.

Optionally, the number of information bits corresponding to the beam indicator is determined based on a parameter (NSetA). Here, NSetA may represent the number of beams (or, resources) used for prediction. Optionally, NSetA may represent the number of beams (or, resources) in a beam set (or, a resource set) used for prediction. The beam indicator (k) is used for prediction (and/or beam prediction, and/or UE-side prediction, and/or spatial domain prediction, and/or time domain prediction). For example, the number of information bits corresponding to the beam indicator is ┌log₂ N_{SetA}┘. For example, k is an integer ranging from 0 to NSetA−1. For example, k=0 represents the first predicted beam; k=1 represents the second predicted beam; and so on. Optionally, the beam indicator may be associated with NSetA reference signals (e.g., aperiodic reference signals or semi-persistent reference signals), or NSetA SSBs.

For example, k=0 indicates the first reference signal or the first SSB; k=1 indicates the second reference signal or the second SSB; and so on. Optionally, information for the NSetA reference signals, or information for the NSetA SSBs is indicated/configured via RRC signaling. Optionally, NSetA may be predefined, for example, NSetA may be one of 1, 2, 3, 4, 5, 6, 7, 8. Optionally, the NSetA may be based on UE capability. Optionally, the NSetA may be indicated by the (reported) UE capability signaling. Optionally, the NSetA may be indicated by the base station (e.g., via at least one of RRC, MAC-CE, DCI). Optionally, when NSetA is not configured, the value (or default value) of NSetA is 16. Optionally, NSetA may be determined based on the number of SSBs transmitted in a half-frame. Optionally, when NSetA is not configured, the value (or default value) of NSetA is determined based on the number of SSBs transmitted in a half-frame. For example, the value of NSetA is equal to the number of transmitted SSB corresponding to a higher layer parameter (e.g., ssb-PositionsInBurst).

Optionally, when the beam indicator (or, the value of the beam indicator) is used for prediction, L1-RSRP corresponding to the beam indicator is the predicted L1-RSRP (or L1-RSRP for prediction).

Optionally, when the CSI parameter is associated with time interval(s), the CSI parameter (or all parameters included in the CSI parameter) is the predicted CSI parameter (or, used for the predicted CSI parameter). Optionally, a time interval may be a set of consecutive time units. Optionally, the earliest time unit in the set of consecutive time units is referred as a starting time unit. Optionally, the last time unit in the set of consecutive time units is referred as an ending time unit. Optionally, the time interval may be a time unit.

How the time domain position of the time interval(s) corresponding to the CSI parameter is determined is described below.

Optionally, the CSI parameter is (predicted) for F (F≥1) time intervals. For example, the CSI parameter may include/correspond to the CSI parameter for each of F time intervals. For example, the CSI parameter is predicted for (each of) F time intervals.

Optionally, F may be predefined, for example, F may be one of 1, 2, 3, 4, 5, 6, 7, 8. Optionally, F may be based on UE capability. Optionally, F may be indicated by the (reported) UE capability signaling. Optionally, F may be indicated by the base station (e.g., via at least one of RRC, MAC-CE, DCI). Optionally, when F is not configured, the value (or default value) of F is 1.

Optionally, a length of one (or each) of F time intervals may be determined based on at least one of: periodicity of the first resource or a spacing of two adjacent resource groups from P resource groups; a parameter T_{future} (T_{future}≥1). Here, T_{future} may be the parameter for determining the length of a time interval. Refer to one or more embodiments disclosed herein for description for the periodicity of the first resource and the spacing (e.g., G) of two adjacent resource groups from P resource groups. Optionally, the length of a time interval may be based on/equal to the length of the periodicity of T_{future} (T_{future}≥1) first resource. Optionally, the length of a time interval (or each time interval) may be determined by T_{future} time units. Optionally, T_{future} may be predefined, e.g., one of 1, 2, 3, 4. Optionally, the time unit may be a slot or a symbol. Optionally, the slot may be an uplink slot or a downlink slot. Optionally, the time unit may be a millisecond or a frame or a subframe. Optionally, T_{future} may be based on UE capability. Optionally, T_{future} may be indicated by the (reported) UE capability signaling. Optionally, T_{future} may be indicated by the base station (e.g., via at least one of RRC, MAC-CE, DCI).

When the time unit corresponding to the periodicity of the first resource is ms/sec/subframe (e.g., when the first resource corresponds to an SSB), the length of the periodicity of the first resource may be converted/scaled from a specific millisecond to corresponding slot(s), thereby specifying the parameter corresponding to the length of the periodicity of the first resource, improving reliability of the communication system. Optionally, the time unit corresponding to the periodicity of the first resource (e.g., the time unit corresponding to the length of the time interval) is determined based on (the length of) the periodicity of the first resource and the subcarrier spacing configuration. Optionally, the method is applicable to the case when the resource set of the signal for channel measurement is periodic/semi-persistent, or the signal for channel measurement is SSB. Optionally, the parameter of the length of the time interval corresponding to the periodicity of the first resource is determined based on (the length of) the periodicity of the first resource and/or the uplink subcarrier spacing configuration and/or the downlink subcarrier spacing configuration. Optionally, the length of the time interval may be based on/may be/may be equal to T_{future}*P_{RS}*Nₛₗₒₜ^{subframe,μ}. Where P_{RS} represents the periodicity of the first resource (e.g., the periodicity of SSB); μ corresponds to the uplink subcarrier spacing configuration, or, to the downlink subcarrier spacing configuration. Here, the uplink subcarrier spacing configuration may be the subcarrier spacing configuration for the CSI report. Here, the subcarrier spacing configuration for the CSI report is, for example, the SCS configuration of the UL BWP the CSI report is transmitted on. Optionally, the downlink subcarrier spacing configuration may be the subcarrier spacing for SSB. Here, the subcarrier spacing configuration transmitted for SSB is, for example, the SCS configuration of the DL BWP the SSB is transmitted on. Optionally, the downlink subcarrier spacing configuration may be/correspond to the SCS configuration of the active DL BWP.

When the time unit corresponding to the periodicity of the first resource is a slot (e.g., when the first resource corresponds to the CSI-RS resource), the time unit associated with the CSI parameter may be an uplink time unit, so that the downlink slot of the first resource needs to be scaled to an uplink slot in order to clarify the parameter corresponding to the length of the first resource, improving the reliability of the communication system. Optionally, the time unit corresponding to the periodicity of the first resource (e.g., the time unit corresponding to the length of the time interval) is determined based on (the length of) the periodicity of the first resource and/or the uplink subcarrier spacing configuration and/or the downlink subcarrier spacing configuration. Optionally, the method is applicable to the case when the resource set of the signal for channel measurement is aperiodic or the signal for channel measurement is CSI-RS. Optionally, the length of the time interval may be/equal to

$${T}_{future} * {P}_{RS} * \frac{{μ}_{DL}}{{μ}_{UL}} ,$$

$$or$$

$${T}_{future} * ⌈ {P}_{RS} * \frac{{μ}_{DL}}{{μ}_{UL}} ⌉ ,$$

$$or$$

$${T}_{future} * ⌊ {P}_{RS} * \frac{{μ}_{DL}}{{μ}_{UL}} ⌋ .$$

Where P_{RS} represents the periodicity of the first resource (e.g., the periodicity of reference signal/CSI-RS); μ_{DL} corresponds to the downlink subcarrier spacing configuration; μ_{UL} corresponds to the uplink subcarrier spacing configuration.

Optionally, the uplink subcarrier spacing configuration may be the subcarrier spacing configuration for the CSI report. Here, the subcarrier spacing configuration for the CSI report is, for example, the SCS configuration of the UL BWP the CSI report is transmitted on. Optionally, the downlink subcarrier spacing configuration may be the subcarrier spacing for CSI-RS. Here, the subcarrier spacing configuration for CSI-RS transmission is, for example, the SCS configuration of the DL BWP the CSI-RS is transmitted on. Optionally, the downlink subcarrier spacing configuration could be/correspond to the SCS configuration of the active DL BWP.

Optionally, the time domain position of one of F time intervals may be determined based on one of: the CSI reference resource; the time unit where the CSI report is located; a fourth offset. Optionally, the CSI reference resource may be the CSI reference resource for the corresponding CSI report configuration. Optionally, the CSI reference resource may be the CSI reference resource carrying/including the CSI report of the CSI parameter. Optionally, the time unit where the CSI report is located is offset from the one (or, earliest/first) time unit of the one (or the first/earliest) one of F time intervals by the fourth offset. It should be noted that the fourth offset may be a positive integer or a negative integer. When the fourth offset is a positive integer, the offset indicates that the time interval (or the first time unit of the time interval) is after the time unit where the CSI report is located. When the fourth offset is a negative integer, the offset indicates that the time interval (or the first time unit of the time interval) is before the time unit where the CSI report is located. When the fourth offset is 0, the offset indicates that the time interval (or the first time unit of the time interval) is the same as the time unit where the CSI report is located. Here, the time unit where the CSI report is located may be slot n or uplink slot n. Optionally, the fourth offset may be predefined, e.g., one of −4, −3, −2, −1, 0, 1, 2, 3, 4, −n_{ref}. Wherein the fourth offset is determined based on the CSI reference resource.

For example, when the fourth offset is −n_{ref}, one (or, the earliest/first) time unit of one (or the first/earliest) one of F time intervals corresponds to/is associated with/refers to the (uplink/downlink) slot where the CSI reference resource is located. Optionally, the fourth offset may be based on UE capability. Optionally, the fourth offset may be indicated by the (reported) UE capability signaling. Optionally, the fourth offset may be indicated by the base station (e.g., via at least one of RRC, MAC-CE, DCI). Here, the time unit may be a slot or a symbol. Optionally, the time unit may be an uplink slot or an uplink symbol. Optionally, the time unit may be a downlink slot or a downlink symbol. Take the uplink slot as an example, the CSI report is transmitted in uplink slot n, then the uplink slot corresponding to the earliest of the F slots (or corresponding to the first uplink slot) is slot n+offset4. Where offset4 represents the fourth offset.

Optionally, the first one of F time intervals may be determined based on one or more windows determined by the first resource. Optionally, (the starting/ending time unit of) the first one of F time intervals may be based on/may be no earlier (or later) than (the starting/ending time unit of) the first one of the one or more windows determined by the first resource. Optionally, (the starting/ending time unit of) the first one of F time intervals may be based on/may be no earlier (or later) than (the starting/ending time unit of) the first one of the one or more windows determined by the first resource (or the time unit where the CSI reference resource is located). Refer to one or more embodiments disclosed herein for description of the method for the one or more windows determined by the first resource.

Optionally, F time intervals may be equally spaced/equally offset. For example, all time intervals of F time intervals are arranged in time order, and the interval between each two neighboring time intervals is equal. Optionally, the spacing/offset may be the spacing/offset between neighboring time intervals. Optionally, the spacing/offset may be the spacing/offset between the starting time unit or the ending time unit between neighboring time intervals. Optionally, the spacing may also be the spacing/offset between the first/earliest of F time intervals and other time intervals (e.g., other F−1 time intervals). Optionally, the spacing/offset may be the spacing/offset between the starting time unit or the ending time unit between time intervals (or neighboring time intervals). Optionally, the spacing/offset may be determined based on at least one of: the periodicity of the first resource or the spacing of two adjacent resource groups from P resource groups; a parameter T_{gap} (T_{gap}≥1). Here, T_{gap} may be used to determine the interval between time intervals. The periodicity of the first resource and the spacing (e.g., G) of two adjacent resource groups from P resource groups are described with reference to one or more embodiments disclosed herein.

Optionally, the length of a time interval may be equal to the length of T_{gap} (T_{gap}>1) periodicities of the first resource. Optionally, the length of a time interval (or each time interval) may be determined by T_{gap} time units. Optionally, T_{gap} may be predefined, e.g., one of 1, 2, 3, 4. Optionally, the time unit may be a slot or a symbol. Optionally, the slot may be an uplink slot or a downlink slot. Optionally, the time unit may be a millisecond or a frame or a subframe. Optionally, T_{gap} may be based on UE capability. Optionally, T_{gap} may be indicated by the (reported) UE capability signaling. Optionally, T_{gap} may be indicated by the base station (e.g., via at least one of RRC, MAC-CE, DCI).

When the time unit corresponding to the periodicity of the first resource is ms/sec/subframe (e.g., when the first resource corresponds to an SSB), the length of the periodicity of the first resource may be converted/scaled from a specific ms to a corresponding slot, thereby specifying the parameter corresponding to the length of the first resource, improving reliability of the communication system. Optionally, the time unit corresponding to the periodicity of the first resource (e.g., the time unit corresponding to the interval between the time intervals) is determined based on (the length of) the periodicity of the first resource and the subcarrier spacing configuration. Optionally, the method is applicable when the resource set of the signal for channel measurement is periodic/semi-persistent, or the signal for channel measurement is SSB. Optionally, the parameter of the length of the time interval corresponding to the periodicity of the first resource is determined based on (the length of) the periodicity of the first resource and/or the uplink subcarrier spacing configuration and/or the downlink subcarrier spacing configuration. Optionally, the interval of the time interval may be/equal to T_{gap}*P_{RS}*Nₛₗₒₜ^{subframe,μ}. Where P_{RS} represents the periodicity of the first resource (e.g., the periodicity of SSB); μ corresponds to the uplink subcarrier spacing configuration or, to the downlink subcarrier spacing configuration. Here, the uplink subcarrier spacing configuration may be the subcarrier spacing configuration for the CSI report. Here, the subcarrier spacing configuration for the CSI report is, for example, the SCS configuration of the UL BWP the CSI report is transmitted on. Optionally, the downlink subcarrier spacing configuration may be the subcarrier spacing for SSB. Here, the subcarrier spacing configuration transmitted for SSB is, for example, the SCS configuration of the DL BWP SSB is transmitted on. Optionally, the downlink subcarrier spacing configuration could be/correspond to the SCS configuration of the active DL BWP.

When the time unit corresponding to the periodicity of the first resource is a slot (e.g., when the first resource corresponds to the CSI-RS resource), the time unit associated with the CSI parameter may be an uplink time unit, so that the downlink slot of the first resource needs to be scaled to an uplink slot in order to clarify the parameter corresponding to the length of the first resource, improving the reliability of the communication system. Optionally, the time unit (e.g., the time unit corresponding to the interval between time intervals) corresponding to the periodicity of the first resource is determined based on (the length of) the periodicity of the first resource and/or the uplink subcarrier spacing configuration and/or the downlink subcarrier spacing configuration. Optionally, the method is applicable to the case when the resource set of the signal for channel measurement is aperiodic or the signal for channel measurement is CSI-RS. Optionally, the spacing of time intervals may be/equal to

$${T}_{gap} * {P}_{RS} * \frac{{μ}_{DL}}{{μ}_{UL}} ,$$

$$or$$

$${T}_{future} * ⌈ {P}_{RS} * \frac{{μ}_{DL}}{{μ}_{UL}} ⌉ ,$$

$$or$$

$${T}_{future} * ⌊ {P}_{RS} * \frac{{μ}_{DL}}{{μ}_{UL}} ⌋ .$$

Where PRS represents the periodicity of the first resource (e.g., the periodicity of reference signal/CSI-RS); μ_{DL} corresponds to the downlink subcarrier spacing configuration; μ_{UL} corresponds to the uplink subcarrier spacing configuration. Optionally, the uplink subcarrier spacing configuration may be the subcarrier spacing configuration for the CSI report. Here, the subcarrier spacing configuration for the CSI report is, for example, the SCS configuration of the UL BWP the CSI report is transmitted on. Optionally, the downlink subcarrier spacing configuration may be the subcarrier spacing for CSI-RS. Here, the subcarrier spacing configuration for CSI-RS transmission is, for example, the SCS configuration of the DL BWP the CSI-RS is transmitted on. Optionally, the downlink subcarrier spacing configuration could be/correspond to the SCS configuration of the active DL BWP.

How F time intervals associated with the CSI parameter are determined is described above, and how the CSI parameter is determined and/or associated with F time intervals is described below.

Below is described by taking the CSI parameter as the beam indicator and/or the value of L1-RSRP as an example.

Optionally, the CSI parameter includes/corresponds to the CSI parameter for one (, or at least one or each) time interval of F time intervals. Optionally, the CSI parameter is the CSI parameter used for prediction (e.g., for CSI prediction). Optionally, the CSI parameter for one (, or at least one or each) of F time intervals is in the same report or in a report. The CSI parameter corresponding to the time interval may be understood as that the CSI parameter is for the time interval or that the CSI parameter is predicted for the time interval.

Optionally, the CSI parameter corresponding to at least one (or, each) time interval includes/corresponds to/is associated with N_{reportRS} (N_{reportRS}≥1) values of L1-RSRP. Optionally, N_{reportRS} may represent the number of beams (of the corresponding CSI parameter/value of L1-RSRP) that are reported or not reported. Optionally, N_{reportRS} may represent the number of beams (of the corresponding CSI parameter/value of L1-RSRP) that are reported or not reported corresponding to each time interval. Optionally, N_{reportRS} may be predefined. For example, N_{reportRS} may be at least one of 1, 2, 3, 4, Kₛ. Optionally, N_{reportRS} may be determined based on UE capability signaling. For example, N_{reportRS} is indicated based on the (reported) UE capability signaling. Optionally, N_{reportRS} may be determined based on UE capability signaling. For example, N_{reportRS} may be indicated by the base station. For example, N_{reportRS} is configured via RRC signaling (e.g., nrofReportedRS in CSI-ReportConfig). Optionally, N_{reportRS} may be indicated by MAC-CE signaling. Optionally, MAC-CE may be a signaling for triggering the CSI report corresponding to the CSI configuration information. MAC-CE includes/corresponds to an (explicit) indication of N_{reportRS}; or the triggering state indicated by MAC-CE includes/corresponds to an indication of N_{reportRS}. For example, N_{reportRS} is configured via DCI signaling. Optionally, DCI may be a signaling for triggering the CSI report corresponding to the CSI configuration information. DCI (e.g., corresponding to DCI format 0_1 or DCI format 0_2) includes/corresponds to an (explicit) indication of N_{reportRS}; or the triggering state indicated by DCI includes/corresponds to an indication of N_{reportRS}.

Optionally, the CSI parameter may include/correspond to/be associated with at least one (or each) time interval corresponding to (one, or N_{reportRS}) beam indicator.

Optionally, when N_{reportRS} is equal to the number of the resource included in/corresponding to the first resource (e.g., N_{reportRS}=Kₛ), the CSI parameter includes/corresponds to a beam indicator corresponding to at least one (or, each) time interval. Optionally, the beam indicator indicates/represents the beam corresponding to the largest predicted value of L1-RSRP in the time interval determined based on the time interval indicator (refer below for the description of the time interval indicator). Optionally, the beam indicators (e.g., F beam indicators) indicate the beam (or corresponding beam indicator) corresponding to the largest predicted value of L1-RSRP in each time interval. Optionally, the above method is applicable to the case where the configured reference signal (or the set of reference signals) for channel measurement is periodic or semi-persistent.

Optionally, when N_{reportRS} is equal to the number of the resource in the resource group included in/corresponding to the first resource (e.g., N_{reportRS}=N_{group}), the CSI parameter includes/corresponds to a beam indicator corresponding to at least one (or, each) time interval. Optionally, the beam indicator indicates the beam corresponding to the largest measured value of L1-RSRP in the time interval determined based on the time interval indicator (refer below for the description of the time interval indicator). Optionally, the time interval indicators (e.g., F time interval indicators) indicate the beam corresponding to the largest measured value of L1-RSRP in each time interval. Optionally, the above method is applicable to the case where the configured reference signal (or the set of reference signals) for channel measurement is aperiodic.

Optionally, the CSI parameter may include/correspond to/be associated with N_{reportRS} first beam indicators corresponding to at least one (or, each) time interval. Here, the first beam indicator is used to indicate/represent the reported/measured/predicted beam; or the first beam indicator is used to indicate/represent the reported/measured/predicted beam for the corresponding time interval.

Optionally, the CSI parameter may include N_{reportRS} beam indicators corresponding to at least one (or, each) time interval when the first condition associated with N_{reportRS} and Kₛ is satisfied (e.g., N_{reportRS} is less than or equal to Kₛ/2, or N_{reportRS} is less than or equal to round up or round down of Kₛ/2, or N_{reportRS} is less than Kₛ). N_{reportRS} beam indicators represent (reported/predicted/measured) beams; or Kₛ−N_{reportRS} beam indicators indicate beams that are not reported. Optionally, Kₛ in the above equation may be replaced by Kₛ+1. For example, Kₛ/2 may be replaced by

$$\frac{{K}_{s} + 1}{2} .$$

A benefit of the method is that the number of beam indicators included in the CSI parameter can be reduced, thereby reducing the overhead of CSI report and improving the efficiency of the communication system. Optionally, the above method is applicable to the case where the configured reference signal (or the set of reference signals) for channel measurement is periodic or semi-persistent.

Optionally, the CSI parameter may include N_{reportRS} beam indicators corresponding to at least one (or, each) time interval when the first condition associated with N_{reportRS} and N_{group} is satisfied (e.g., N_{reportRS} is less than or equal to N_{group}/2, or N_{reportRS} is less than or equal to the round up or round down of N_{group}/2, or N_{reportRS} is less than N_{group}). N_{reportRS} beam indicators represent (reported/predicted/measured) beams; or N_{group}−N_{reportRS} beam indicators indicate the beams that are not reported. Optionally, N_{group} in the above equation may be replaced by N_{group}+1. For example, N_{group}/2 may be replaced by

$$\frac{{N}_{group} + 1}{2} .$$

A benefit of the method is that the number of beam indicators included in the CSI parameter can be reduced, thereby reducing the overhead of CSI report and improving the efficiency of the communication system. Optionally, the above method is applicable to the case where the configured reference signal (or the set of reference signals) for channel measurement is aperiodic.

Optionally, the CSI parameter may include/correspond to/be associated with Kₛ−N_{reportRS} (or N_{group}−N_{reportRS}) second beam indicators corresponding to at least one (or, each) time point. Here, the second beam indicator is used to indicate/represent the beam that is not reported/not measured/not predicted; or the second beam indicator is used to indicate/represent the beam corresponding to each time interval that is not reported/not measured/not predicted.

Optionally, the CSI parameter may include Kₛ−N_{reportRS} beam indicators (e.g., CRI or SSBRI) corresponding to at least one (or each) time interval when the second condition associated with N_{reportRS} and Kₛ is satisfied (e.g., N_{reportRS} is greater than or equal to Kₛ/2, or N_{reportRS} is greater than or equal to the round up or round down of Kₛ/2, and/or N_{reportRS}<Kₛ, or N_{reportRS}=Kₛ). Kₛ−N_{reportRS} beam indicators represent the beams (corresponding to each time interval) that are not reported/not measured/not predicted; or Kₛ−N_{reportRS} beam indicators indicate beams that are not reported. Optionally, Kₛ in the above equation may be replaced by Kₛ+1. For example, Kₛ/2 may be replaced by

$$\frac{{K}_{s} + 1}{2} .$$

Optionally, Kₛ/2 in the above equation may be replaced by

$$\frac{P * {K}_{s} + 1}{2 P} .$$

A benefit of the method is that the number of beam indicators included in the CSI parameter can be reduced, thereby reducing the overhead of CSI report and improving the efficiency of the communication system. Optionally, the above method is applicable to the case where the configured reference signal (or the set of reference signals) for channel measurement is periodic or semi-persistent.

Optionally, the CSI parameter may include N_{group}−N_{reportRS} beam indicators (e.g., CRI or SSBRI) corresponding to at least one (or each) time interval when the second condition associated with N_{reportRS} and N_{group} is satisfied (e.g., N_{reportRS} is greater than or equal to N_{group}/2, or N_{reportRS} is greater than or equal to the round up or round down of N_{group}/2, and/or N_{reportRS}<N_{group}, or N_{reportRS}=N_{group}). N_{group}−N_{reportRS} beam indicators indicate beams (corresponding to each time interval) that are not reported/not measured/not predicted; or N_{group}−N_{reportRS} beam indicators indicate beams that are not reported. Optionally, N_{group} in the above equation may be replaced by N_{group}+1. For example, N_{group}/2 may be replaced by

$$\frac{{N}_{group} + 1}{2} .$$

Optionally, N_{group}/2 in the above equation may be replaced by

$$\frac{P * {N}_{group} + 1}{2 P} .$$

A benefit of the method is that the number of beam indicators included in the CSI parameter can be reduced, thereby reducing the overhead of CSI report and improving the efficiency of the communication system. Optionally, the above method is applicable to the case where the configured reference signal (or the set of reference signals) for channel measurement is aperiodic.

Optionally, F time intervals may share the same resource indicator. For example, the UE may select a specific subset of beams (e.g., N_{reportRS} beams), which is applicable to all/every time interval. Thus, for F time intervals, the number/total number of beam indicators included in/corresponding to the CSI parameter may be N_{reportRS} or Kₛ−N_{reportRS} Or N_{group}−N_{reportRS}. Optionally, F time intervals may each have a respective beam indicator. For example, for each time interval, the UE may select a specific subset of the resource, which is applicable to the corresponding time interval. Thus, for F time intervals, the number/total number of beam indicators included in/corresponding to the CSI parameter may be P*N_{reportRS} or P*(Kₛ−N_{reportRS}) or P*(N_{group}−N_{reportRS}).

Optionally, (the CSI report corresponding to) the CSI report configuration corresponds/uses differential L1-RSRP based reporting. Optionally, the CSI parameter may include/correspond to one or more values of L1-RSRPs (e.g., predicted value of L1-RSRP). Optionally, the values of L1-RSRPs of the one or more values of L1-RSRPs other than the largest predicted value are with reference to the largest predicted value. Optionally, the largest predicted value of L1-RSRP may be quantized to a 7-bit value in the range [−140, −44] dBm with 1 dB step size. Optionally, the differential L1-RSRP may be quantized to a 4-bit value. Optionally, the value of the differential L1-RSRP is computed with 2 dB step size with reference to the largest predicted value of L1-RSRP. Optionally, the largest predicted value of L1-RSRP is part of the same L1-RSRP reporting instance. Optionally, the largest predicted value of L1-RSRP and differential value of L1-RSRP correspond to the same time interval.

The following method is to determine the time interval corresponding to the largest predicted value of L1-RSRP and the corresponding resource, so as to further determine other differential values of L1-RSRP based on the largest predicted value of L1-RSRP, so that the UE and the network device have the same understanding of L1-RSRP, improving the reliability of the communication system. Optionally, the CSI parameter may include/correspond to a time interval indicator and/or a corresponding beam indicator. Optionally, the time interval indicator is used to indicate/represent the time interval where the largest predicted value of L1-RSRP is located. Optionally, when the largest predicted value of L1-RSRP is in the same L1-RSRP reporting as the differential value of L1-RSRP, the CSI parameter may include/correspond to the time interval indicator. Optionally, the bitwidth (of the CSI field) corresponding to the CSI parameter (e.g., the time interval indicator) is determined based on the number (e.g., F) of the time intervals.

For example, the bitwidth of the CSI field corresponding to the time interval indicator parameter is ┌log₂ F┘. Optionally, the CSI parameter may include/correspond to the beam indicator corresponding to the time interval indicator. Optionally, when the second condition is satisfied, the CSI parameter may include/correspond to the beam indicator corresponding to the time interval indicator. Optionally, the beam indicator is used to indicate the beam corresponding to the largest predicted value of L1-RSRP associated with/corresponding to the time interval corresponding to the time interval indicator. Optionally, the beam corresponding to the largest predicted value of L1-RSRP corresponding to the time interval indicated by the time interval indicator may be indicated by the first/last (or lowest/highest numbered) of N_{reportRS} (reported) first beam indicator. Optionally, when the first condition is satisfied, the largest predicted value of L1-RSRP for the time interval indicated by the time interval indicator may be the first/last (or the lowest/highest numbered) of N_{reportRS} first resource indicators. Optionally, other than the above-described L1-RSRP determined by the time interval indicator and the corresponding beam indicator, other L1-RSRPs (e.g., of other P−1 time intervals) are differential L1-RSRPs. For example, L1-RSRPs corresponding to three time intervals are {L1-RSRP #1, L1-RSRP #2}, {L1-RSRP #3, L1-RSRP #4}, {L1-RSRP #5, L1-RSRP #6}, respectively. When the time interval indicator indicates 0 (e.g., the first time interval) and the beam indicator indicates the first beam, the first L1-RSRP (e.g., L1-RSRP #1) is a 7-bit quantized value (the largest predicted value of L1-RSRP), L1-RSRP #2, L1-RSRP #3, L1-RSRP #4, L1-RSRP #5, L1-RSRP #6 are all 4-bit quantized values with reference to L1-RSRP #1. Optionally, the CSI parameter may include a beam indicator of one (, or at least one or each) time interval. Optionally, the beam indicator is used to represent the beam corresponding to the largest predicted value of L1-RSRP for the corresponding time interval.

For example, the CSI parameter may include a beam indicator of one (, or at least or each) time interval (respectively) used to represent/indicate the largest predicted value of L1-RSRP for the corresponding time interval. Optionally, the beam corresponding to the largest predicted value of L1-RSRP in at least one (or each) time interval may be indicated by the first/last (or lowest/highest numbered) of N_{reportRS} (reported) first beam indicators. For example, L1-RSRPs corresponding to three time intervals are {L1-RSRP #1, L1-RSRP #2}, {L1-RSRP #3, L1-RSRP #4}, {L1-RSRP #5, L1-RSRP #6}, respectively, and each time interval indicator indicates the first beam, the second beam, the first beam, respectively. Here, L1-RSRP #1, L1-RSRP #4, L1-RSRP #5 are 7-bit quantized values. L1-RSRP #2, L1-RSRP #3, L1-RSRP #6 are 4-bit quantitated values with reference to L1-RSRP #1, L1-RSRP #4, L1-RSRP #5, respectively.

Optionally, (the order of) the CSI parameter is determined based on at least one of: the order of F time intervals, the order of the CSI parameter. Optionally, the CSI parameter refers to the order of information bits (or the sequential order of information bits) corresponding to the CSI parameter. Here, the order of F time intervals may be the order of the time intervals corresponding to the CSI parameter.

Optionally, the order of F time intervals may be the order of F time intervals in the time domain (e.g., the sequential order in the time domain). Optionally, the sequential order of F time intervals in the time domain refers to the sequential order of the first/last time unit of F time intervals in the time domain. For example, there are two time intervals, time interval #1 corresponds to slot #1 and slot #2; time interval #1 corresponds to slot #2 and slot #3. Since the first slot (or the starting slot) of time interval #1 is earlier than the first slot (or the starting slot) of time interval #2, time interval #1 is earlier than time interval #2.

Optionally, the order of F time intervals may be the order of the IDs corresponding to F time intervals. For example, each time interval may be configured with an ID. The order of F time intervals may be an ascending/descending order of the configured ID of F time intervals. For example, each time interval may be assigned an ID. The order of F time intervals may be an ascending/descending order of the assigned IDs of F time intervals. Here, the ID may be assigned in the sequential order based on the time interval. For example, the value of the ID corresponding to the first/earliest time interval of F time intervals is 0; the value of the ID corresponding to the second one of F time intervals is 1; and so on. For example, the value of the ID corresponding to the first/earliest time interval of F time intervals is 1; the value of the ID corresponding to the second one of F time intervals is 2; and so on.

Optionally, the order of F time intervals may be the order of F time intervals in the corresponding configuration signaling. For example, the first one of F time intervals refers to the first configured time interval (e.g., in RRC signaling); the second time interval of F time intervals refers to the second configured time interval (e.g., in RRC signaling); and so on.

Optionally, the order of CSI parameter may be an order of the types of the CSI parameter. Here, the types of the CSI parameter may include the value of L1-RSRP and CRI (and/or a time interval indicator), or the value of L1-RSRP and an SSBRI (and/or a time interval indicator). When the types of the CSI parameter include the value of L1-RSRP and CRI, the (sequential) order of the types of the CSI parameter are CRI, the value of L1-RSRP. When the types of the CSI parameter include the value of L1-RSRP and SSBRI, the (sequential) order of the types of the CSI parameter are SSBRI, the value of L1-RSRP. When the types of CSI parameter include the value of L1-RSRP and CRI and the time interval indicator, the (sequential) order of the types of the CSI parameter is the time interval indicator, CRI, the value of L1-RSRP; or, a CRI, the value of L1-RSRP, the time interval indicator. When the types of CSI parameter include the value of L1-RSRP and SSBRI and the time interval indicator, the (sequential) order of the types of the CSI parameter is the time interval indicator, SSBRI, the value of L1-RSRP, or SSBRI, the value of L1-RSRP, the time interval indicator. The sequential order here is exemplary and their sequential order may be interchangeable.

Optionally, the order of the CSI parameter may be the order of the quantization corresponding to the CSI parameter (e.g., L1-RSRP). Here, the quantization may include non-differential quantization and differential quantization. Optionally, the non-differential quantization may be referred as absolute quantization (e.g., the quantization corresponding to the largest predicted value of L1-RSRP described above). Optionally, differential quantization represents the quantization that is with reference to other predicted values/quantitated values (the difference value is quantized) (e.g., the above-described quantization that is with reference to the largest predicted value of L1-RSRP). Optionally, the (sequential) order of the quantization corresponding to the CSI parameter (e.g., L1-RSRP) may be: non-differential quantization, differential quantization; or, differential quantization, non-differential quantization.

Optionally, the order of the CSI parameter may be the order of the indexes corresponding to the CSI parameter (e.g., L1-RSRP). Optionally, it may be numbered accordingly (in order) based on the number of the reported CSI parameter (the values of L1-RSRP/the beam indicator). For example, when N_{reportRS} beam indicators are reported, they may be numbered as beam indicator #1, beam indicator #2, beam indicator #N_{reportRS}. For example, when N_{reportRS} beam indicators are reported, they may be numbered as beam indicator #0, beam indicator #1, . . . , beam indicator #N_{reportRS}−1. Optionally, the order of the indexes corresponding to the CSI parameter may be an ascending order or a descending order of the indexes corresponding to the CSI parameter. Optionally, the largest predicted value of L1-RSRP and/or the beam indicator corresponding to the largest predicted value of L1-RSRP may correspond to the first index. Optionally, in the time interval indicated by the time interval indicator, the largest predicted value of L1-RSRP and/or the beam indicator corresponding to the largest predicted value of L1-RSRP may correspond to the first index.

Optionally, the CSI parameter may be first based on the order of the CSI parameter, then based on the order of F time intervals. The sequential order here is exemplary and their sequential order may be interchangeable.

Optionally, the CSI parameter may be first based on the order of the types of the CSI parameter, then based on the quantization corresponding to the CSI parameter, then based on the order of F time intervals, and then based on the order of CSI parameter indexes. The sequential order here is exemplary and their sequential order may be interchangeable.

Optionally, the number/interval/length of the time intervals corresponding to the beam indicator may be the same as or may be different from the number/interval/length of the time intervals corresponding to the value of L1-RSRP. For example, the number/interval/length of the time intervals corresponding to the beam indicator is based on the first periodicity. For example, the number/interval/length of the time intervals corresponding to the values of L1-RSRP is based on slots (e.g., a slot).

Optionally, when the UE supports the capability of time domain prediction and/or the capability of spatial domain prediction, the UE may perform the method of one or more embodiments disclosed herein.

Optionally, when the UE supports the capability of UE-side prediction, the UE may perform the method of one or more embodiments disclosed herein.

Optionally, when the UE supports the capability of (UE-side) time domain prediction and/or the capability of (UE-side) spatial domain prediction, the UE may perform the method of one or more embodiments disclosed herein.

Optionally, “prediction” may be understood as “beam prediction.”

One or more embodiments disclosed herein specifies the determination method for the CSI parameter for CSI prediction, so that the base station can reasonably arrange subsequent scheduling based on the predicted CSI parameter, thereby improving performance of a communication system.

In order to enhance the scheduling efficiency of 5G/6G wireless communication systems, an artificial intelligence (AI)/machine learning (ML) related feature may be used in communication systems for communication. However, how to manage the AI/ML related model/feature in the communication system is a problem to be solved.

In a communication system, the AI/ML model may be divided into a base station side model and a UE-side model. In the following, the UE-side model is used as an example to discuss related management methods.

The UE receives configuration information from the base station. The configuration information may be referred as AI configuration information. Optionally, the AI configuration information is used for the UE-side model. Optionally, the AI configuration information associates an AI/ML model or an AI/ML feature. Optionally, the AI configuration information enables/activates the corresponding AI/ML model or AI/ML feature. Optionally, the AI configuration information may include/associate: an association identifier. Optionally, the association identifier is an ID configurated by higher-layer signaling. Optionally, the association identifier is used to determine/ensure the consistency of training (e.g., model training) and inference (e.g., model inference) at UE-side. Optionally, the association identifier is for the AI configuration information.

Optionally, the association identifier is for the AI/ML model or AI/ML feature associated with the AI configuration information. Optionally, the UE may perform operations of life cycle management (LCM) based on the association identifier for the corresponding model. Optionally, the association identifier is for model training and/or model inference at UE-side. Provision of the association identifier to the UE by the base station may help the UE to select the corresponding AI/ML model for operation (e.g., for training, inference, model update, etc.). Optionally, the AI configuration information may include/associate/correspond to: resource configuration information, wherein the resource configuration information may configure a reference signal resource for measurement (e.g., channel measurement and/or interference measurement). Optionally, the AI configuration information may include/associate/correspond to: a CSI report configuration.

Optionally, the AI configuration information may include/associate/correspond to: a model ID. Optionally, the model ID may be for the AI configuration information. Optionally, the model ID included in the AI configuration information may be: a model ID associated with/corresponding to the AI/ML model or AI/ML feature configured by the AI configuration information. Optionally, the AI configuration information may include/associate/correspond to: functionality information and/or model information, which are based on the supported AI-enabled model/feature reported by the UE. Optionally, the AI/ML related model/feature may be/may be defined as the AI-enabled model/feature. Optionally, the AI-enabled model/feature is a feature/model where AI/ML may be used. Optionally, the UE may report the AI-enabled feature supported by the UE. For example, the UE may report the AI-enabled feature supported by the UE via UE capability signaling. For example, the base station indicates the AI-enabled feature used by the UE based on the supported AI-enabled feature reported by the UE. Optionally, the AI-enabled feature includes at least one of: downlink transmission beam prediction; CSI prediction; CSI compression; and positioning.

Optionally, the UE may perform operations related to the AI configuration information. Optionally, the operations associated with the AI configuration information include at least one of the followings:
the UE performs data collection or inference based on the AI configuration information;
the UE performs data collection and/or model inference based on measurement of the reference signal resource associated with the AI configuration information;
the UE reports to the base station based on the result of inference; and/or
the UE reports the result of the model inference to the base station.

Optionally, data obtained in the data collection may be CSI-related information (e.g., channel information, interference information, CQI information, PMI-related information), and/or L1-RSRP-related information, and/or, information related to the resources for measurement (e.g., resource IDs or resource configuration information) and/or, positioning information. Optionally, contents reported by the UE to the base station based on the result of the inference may include: the CSI-related information (e.g., channel information, interference information, CQI information, PMI-related information, RI-related information), and/or the L1-RSRP-related information, and/or, the information related to the resources for measurement (e.g., the resource ID or the resource configuration information) and/or, the positioning information.

Optionally, the UE may determine, based on a timer, that the AI/ML model or the AI/ML feature associated with the AI configuration information is valid (or, whether the information is valid). Optionally, the UE may determine, based on the timer, (whether or not) to operate using/by applying/based on the AI configuration information. Optionally, the UE may determine, based on the timer, (whether) to perform an operation related to the AI configuration information. For example, when the timer is running, the UE may determine that the AI/ML model or AI/ML feature associated with the AI configuration information is valid. For example, when the timer is running, the UE may operate using/by applying the AI configuration information. For example, when the timer is running, the UE performs the operation associated with the AI configuration information. For example, when the timer is not running, the UE may determine that the AI/ML model or AI/ML feature associated with the AI configuration information is invalid. For example, when the timer is not running, the UE does not use/apply the AI configuration information for an operation. For example, when the timer is not running, the UE does not perform the operation associated with the AI configuration information.

For example, when the timer is not running, the UE performs a fallback operation related to the AI/ML model (or the AI/ML feature). Optionally, the fallback operation includes: using/switching to another AI/ML model (or, another AI/ML feature), or, deactivating the AI/ML model (or the AI/ML feature), or, performing the operation in a non-AI/ML manner, or stopping the operation related to the AI configuration information. Optionally, the timer may be for performance monitoring. Optionally, the timer may be for model monitoring. For example, the UE may determine, based on the timer, whether a corresponding AI/ML model (or an AI/ML feature) is valid/appropriate, or whether an operation associated with the corresponding AI/ML model (or an AI/ML feature) is performed. Optionally, the timer may be for the AI/ML model or AI/ML feature associated with the AI configuration information. For example, different AI/ML models or AI/ML features have respective timers.

For example, when the AI/ML feature associated with the AI configuration information is downlink transmission beam prediction, the timer is for downlink transmission beam prediction. For example, when the AI/ML feature associated with the AI configuration information is CSI compression, the timer is for CSI compression. Optionally, the timer may be for the association identifier. For example, different association identifiers have respective timers. For example, the UE determines whether the AI/ML model or the AI/ML feature associated with the AI configuration information is valid based on a timer corresponding to the association identifier associated with the AI configuration information. For example, the UE determines, based on the timer corresponding to the association identifier associated with the AI configuration information, whether or not to use/apply the AI configuration information for an operation. Optionally, the timer may be for a model ID.

For example, the UE determines, based on the timer corresponding to the model ID associated with the AI configuration information, whether or not to use/apply the AI configuration information, or whether or not to perform the operation related to the AI configuration information. The above method may define respective timers for different features or different association identifiers or features which different model IDs are for, so as to perform monitoring accordingly and enhance the flexibility of the communication system. Optionally, the UE may receive/apply the AI configuration information, and/or receive indication information related to the AI configuration information. Optionally, the indication information related to the AI configuration information may be at least one of DCI, MAC-CE, RRC. Optionally, the indication information may trigger a feature configured by the AI configuration information. Optionally, the indication information may indicate/select/activate/deactivate a portion of the feature configured by the AI configuration information.

Optionally, the timer may be associated with time information (e.g., a time threshold, or a time length). Optionally, the UE may be configured with time information for the timer. Optionally, the time information may indicate a number of time units (e.g., at least one of slots, symbols, milliseconds, seconds). Optionally, the time information may be predefined. Optionally, the time information is based on UE capability. For example, the time information corresponding to UEs with different UE capabilities is different. Optionally, the time information is based on the AI/ML model (or based on the AI/ML feature). Optionally, the time information is based on the model ID.

For example, the time information corresponding to different model IDs is different. Optionally, the time information is used for determining a timer state (e.g., running or timeout). Optionally, the time information is used for determining whether the timer times out (or, whether the timer is running). Optionally, the timer is running within a time threshold indicated by the time information after the timer is started (or, restarted). Optionally, the timer is timeout after the time threshold indicated by the time information after the timer is started (or, restarted). Optionally, the timer being stopped or the timer being timeout may be considered as the timer being not running. For example, if the time information is 20 milliseconds, the timer is running within 20 milliseconds after the timer is started; the timer times out after 20 milliseconds after the timer is started.

A Method of operation of the timer is discussed below. Optionally, the timer may be started or stopped. Optionally, the timer may be started by the UE or stopped by the UE. Optionally, the timer starts when at least one of the following conditions is satisfied:
the UE receives/applies the AI configuration information;
the UE receives/applies configuration information or reconfiguration information for the AI configuration information;
the UE receives/applies indication information (or, activation indication) related to the AI configuration information;
the UE receives/applies timer-associated time information;
the UE performs (or, is triggered with) cell selection (or, reselection), or the UE receives/applies cell selection (or, reselection) information;
the AI/ML feature (or, AI/ML model) for the timer is same as the AI/ML feature (or, AI/ML model) associated with the AI configuration information;
the model ID for the timer is same as the model ID associated with the AI configuration information; and/or
the association identifier for the timer is same as the association identifier associated with the AI configuration information. For example, the value of the association identifier for the timer is same as the value of the association identifier associated with the AI configuration information.

A method of operation of the timer is discussed below. Optionally, the timer stops when at least one of the following conditions is satisfied:
the AI configuration information is released;
the UE receives/applies the indication information (or, deactivation indication) related to the AI configuration information;
the UE performs (or, is triggered with) cell selection (or, reselection) or the UE receives/applies cell selection (or, reselection) information;
the UE initiates a beam failure related event;
the AI/ML feature (or, AI/ML model) for the timer is same as the AI/ML feature (or, AI/ML model) associated with the AI configuration information;
the model ID for the timer is same as the model ID associated with the AI configuration information; and/or
the association identifier for the timer is same as the association identifier associated with the AI configuration information. For example, the value of the association identifier for the timer is same as the value of the association identifier associated with the AI configuration information.

Optionally, the base station transmits configuration information (e.g., the AI configuration information) to the UE. Optionally, the base station may receive a report from the UE. Optionally, the AI configuration information is for the UE-side model. Optionally, the report is based on the AI configuration information.

The introduction of the timer may define the applicable time of the AI configuration information and related operations, clarify the range for the disclosure of the corresponding AI/ML model or AI/ML feature in time domain, and avoid the UE from communicating based on expired information associated with inappropriate AI/ML model, and improve the reliability of the communication system.

The present disclosure provides methods that enable the AI/ML related feature to be enhanced, which in turn improves the scheduling efficiency of the communication system.

In the present disclosure, the term “timer starts” is interchangeable with “timer resets” or “timer restarts.”

In the present disclosure, the term “model” is interchangeable with “AI/ML model.”

In the present disclosure, the term “UE capability signaling” is interchangeable with “UE capability.”

In the present disclosure, the term “downlink transmission beam prediction” is interchangeable with “beam prediction” or “downlink beam prediction” or “UE-side beam prediction” or “UE-side downlink beam prediction” or “UE-side downlink transmission beam prediction.”

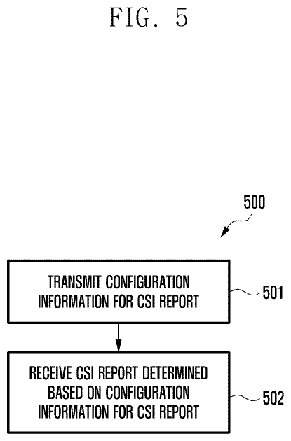

FIG. 5 illustrates a method 500 performed by a base station according to an embodiment of the present disclosure. The method 500 includes, at 501, transmitting, by the base station, configuration information for a CSI report to a user equipment; at 502, receiving, by the base station and from the user equipment, the CSI report determined based on the configuration information for the CSI report.

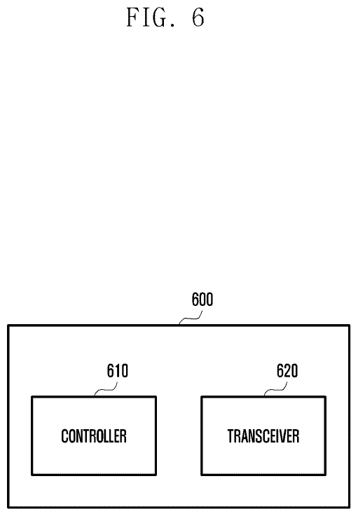

FIG. 6 illustrates a structure 600 of a user equipment according to various embodiments of the present disclosure. As shown in FIG. 6, the user equipment 600 includes a controller 610 configured to perform the various methods disclosed herein above as being performed by the user equipment, and a transceiver 620 configured to transmit/receive channels or signals.

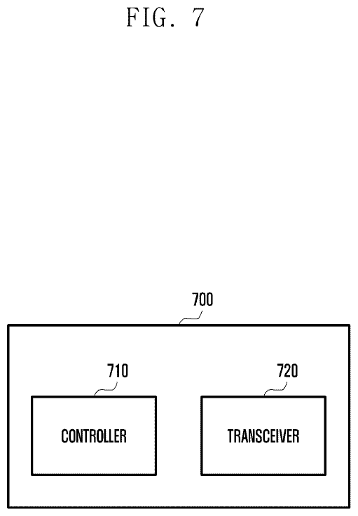

FIG. 7 illustrates a structure 700 of a base station according to various embodiments of the present disclosure. As shown in FIG. 7, the network device 700 includes a controller 710 configured to perform the various methods as disclosed herein above as being performed by the network device, and a transceiver 720 configured to transmit/receive channels or signals.

In the present disclosure, a time unit may be at least one of a slot, a symbol, a frame, a subframe, a half-frame, a sub-slot, a millisecond, a second. Optionally, the slot may be an uplink slot or a downlink slot. Optionally, the symbol may be an uplink symbol or a downlink symbol.

In the present disclosure, the term “CSI report configuration information (e.g., CSI-ReportConfig)” may be used interchangeably with the term “CSI report” or “CSI report configuration” or “configuration information for the CSI report” or “information for configuring CSI report” or “CSI report setting.”

In the present disclosure, “reference signal” may be used interchangeably with “reference signal resource.” And in the present disclosure, “CSI parameter” may be used interchangeably with “CSI,” that is, in the present disclosure, CSI is described taking a CSI parameter as an example.

In the present disclosure, “CSI reference resource of a CSI report configuration” may be used interchangeably with “CSI reference resource associated with the CSI report configuration” and “CSI reference resource corresponding to the CSI report configuration.”

In the present disclosure, “L1-RSRP” may be used interchangeably with “Layer 1-Signal-to-Interference-plus-Noise Ratio (L1-SINR).”

In the present disclosure, “RRC” or “RRC signaling” may be interchangeable with “CSI report configuration” or “sub-configuration.”

In the present disclosure, terms “subcarrier spacing configuration” and “subcarrier spacing” or “numerology” may be interchangeable.

In the present disclosure, terms “CSI-RS” and “NZP CSI-RS” may be interchangeable.

In the present disclosure, resource (e.g., CSI-RS resource, CSI-IM resource) corresponding to a sub-configuration may be understood as resource referenced by sub-configuration. The resource corresponding to the first sub-configuration (or a plurality of first sub-configurations) may be understood as resource referred by the first sub-configuration (or the plurality of first sub-configurations). The resource corresponding to the second sub-configuration may be understood as resource referred by second sub-configuration.

Further, the “at least one” described in the present disclosure includes any and/or all possible combinations of the listed items, various embodiments and various examples of the embodiments described in the present disclosure may be changed and combined in any appropriate form, and “/” described in the present disclosure means “or.”

The various illustrative logical blocks, modules, and circuits described in the present disclosure may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in the present disclosure may be embodied directly in hardware, in a software module executed by a processor, or in a combination of the two. A software module may reside in RAM memory, flash memory, ROM memory, EPROM memory, EEPROM memory, registers, hard disk, a removable disk, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary designs, the functions described may be implemented in hardware, software, firmware, or any combination thereof. If implemented in software, the functions may be stored or transmitted over as one or more instructions or code on a computer-readable medium. Computer-readable media includes both computer storage media and communication media including any medium that facilitates transfer of a computer program from one place to another. A storage medium may be any available medium that can be accessed by a general purpose or special purpose computer.

The description set forth herein, in connection with the appended drawings, describes example configurations, methods, and apparatus and does not represent all the examples that may be implemented or that are within the scope of the claims. The term “example,” when used herein, means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

While the specification contains many specific implementation details, these should not be construed as limitations on the scope of any embodiments or of what may be claimed, but rather as descriptions of features specific to particular embodiments in the present disclosure. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

It is to be understood that the specific order or hierarchy of steps in the methods of the present disclosure is an illustration of exemplary processes. Based upon design preferences, it is understood that the specific order or hierarchy of steps in the methods may be rearranged to achieve the functions and effects disclosed by the present disclosure. The accompanying method claims present elements of the various steps in a sample order, and are not meant to be limited to the specific order or hierarchy presented unless specifically recited otherwise. Furthermore, although elements may be described or claimed in the singular, the plural is contemplated unless limitation to the singular is explicitly stated. Accordingly, the present disclosure is not limited to illustrated examples and any apparatus for performing the functions described herein is included in aspects of the present disclosure.

The text and drawings are provided as examples only to help readers understand the present disclosure. They are not intended and should not be interpreted as limiting the scope of the present disclosure in any way. Although certain embodiments and examples have been provided, based on the content disclosed herein, it is obvious to those skilled in the art that modifications to the illustrated embodiments and examples can be made without departing from the scope of the present disclosure.

Although the present disclosure has been described with various embodiments, various changes and modifications may be suggested to one skilled in the art. It is intended that the present disclosure encompass such changes and modifications as fall within the scope of the appended claims.

What is claimed is:

1. A method performed by a user equipment (UE) in a communication system, the method comprising:
receiving a channel state information (CSI) report configuration, wherein the CSI report configuration comprises information for a first resource;
determining, based on the CSI report configuration, CSI parameter; and
reporting the CSI parameter on the first resource,
wherein:
in case that the first resource is a periodic resource or a semi-persistent resource, and the first resource corresponds to a plurality of measurement occasion groups, the CSI parameter is determined based on each of the plurality of measurement occasion groups, or
in case that the first resource is an aperiodic resource and the first resource comprises a plurality of resource groups in a plurality of time units, the CSI parameter is determined based on each of the plurality of resource groups.

2. The method of claim 1, wherein each measurement occasion group comprises all measurement occasions of one or more resources included in the first resource within a measurement window corresponding to each measurement occasion group.

3. The method of claim 2, wherein a measurement window corresponding to a last measurement occasion group of the plurality of measurement occasion groups is determined based on at least one of:
an offset between a last time unit of a configured measurement window and a CSI reference resource associated with the CSI parameter;
an offset between the last time unit of the configured measurement window and a time unit where the CSI parameter is reported;
a last measurement window of one or more measurement windows determined based on at least one of a periodicity of the first resource or a subframe number (SFN) that is no later than a CSI reference resource associated with the CSI parameter; or
the last measurement window of one or more measurement windows determined based on the at least one of the periodicity of the first resource or the SFN that is no later than a time unit before the time unit where the CSI parameter is reported.

4. The method of claim 3, wherein the last measurement window of the one or more measurement windows that is no later than the CSI reference resource associated with the CSI parameter comprises at least one of:
all measurement occasions in the last measurement window being no later than the CSI reference resource;
at least one of measurement occasions corresponding to each of the one or more resources in the last measurement window being no later than the CSI reference resource; or
the last time unit in the last measurement window being no later than the CSI reference resource.

5. The method of claim 4, wherein:
a length of the measurement window is determined based on the periodicity of the first resource; and
an interval between a plurality of measurement windows corresponding to the plurality of measurement occasion groups is determined based on the periodicity of the first resource.

6. The method of claim 1, wherein each of the plurality of time units is determined based on a reference time unit and one or more first offsets corresponding to one or more resources included in the first resource, or each of the plurality of resource groups corresponds to one or more time units related to the reference time unit, and
wherein the reference time unit is determined based on a channel state information reference signal (CSI-RS) triggering an offset corresponding to the first resource.

7. The method of claim 6, wherein the one or more time units are determined based on one of:
a spacing of two adjacent resource groups from the plurality of resource groups; or
a second offset configured for each resource in each of the plurality of resource groups.

8. The method of claim 1, wherein:
the CSI parameter corresponds to each of the plurality of measurement occasion groups; or
the CSI parameter corresponds to each of the plurality of resource groups.

9. The method of claim 8, wherein:
the CSI parameter corresponding to each measurement occasion group comprises at least one of a resource indicator or a first number of values of layer 1-reference signal received power (L1-RSRP) corresponding to each measurement occasion group; or
the CSI parameter corresponding to each resource group comprises at least one of the resource indicator or the first number of values of L1-RSRP corresponding to each resource group, and
the first number is configured via a higher layer signaling.

10. The method of claim 9, wherein:
the plurality of measurement occasion groups shares a same resource indicator; or
each of the plurality of measurement occasion groups corresponds to a respective resource indicator.

11. The method of claim 9, wherein the resource indicator corresponding to each measurement occasion group or each resource group comprises at least one of:
the first number of a first resource indicator to indicate a resource that is reported; or
a number of a second resource indicator to indicate a resource that is not reported, the number of the second resource indicator being the number of a plurality of resources included in the first resource minus the first number.

12. The method of claim 11, wherein the CSI report configuration corresponds to a differential layer 1-reference signal received power (L1-RSRP) based reporting; and, wherein the CSI parameter comprises:
a group indicator representing each measurement occasion group or a resource group where a largest measured value of L1-RSRP is located or the resource indicator corresponding to the group indicator; or
the CSI parameter comprises a resource indicator corresponding to each measurement occasion group representing the resource corresponding to the largest measured value of L1-RSRP.

13. The method of claim 1, wherein an order of the CSI parameter is determined based on an order of the plurality of measurement occasion groups or an order of the plurality of resource groups.

14. The method of claim 1, wherein the CSI parameter comprises a predicted CSI parameter for each of a second number of time intervals, and
wherein an earliest time interval of the second number of time intervals is determined based on at least one of:
a time unit where the CSI parameter is reported,
a CSI reference resource associated with the CSI report,
a last measurement window of one or more measurement windows determined based on at least one of a periodicity of a first resource or a subframe number (SFN) that is later than the CSI reference resource associated with the CSI parameter, or
the last measurement window of the one or more measurement windows determined based on the at least one of the periodicity of the first resource or the SFN that is not earlier than the time unit where the CSI parameter is reported.

15. The method of claim 14, wherein a spacing between two adjacent time intervals of the second number of time intervals or a length of each of the second number of time intervals is determined based on at least one of:
the periodicity of the first resource; or
the spacing of two adjacent resource groups from the plurality of resource groups.

16. A user equipment (UE) in a communication system, the UE comprising:
a transceiver; and
a processor coupled with the transceiver and configured to:
receive a channel state information (CSI) report configuration, wherein the CSI report configuration comprises information for a first resource;
determine, based on the CSI report configuration, CSI parameter; and
report the CSI parameter on the first resource,
wherein:
in case that the first resource is a periodic resource or a semi-persistent resource, and the first resource corresponds to a plurality of measurement occasion groups, the CSI parameter is determined based on each of the plurality of measurement occasion groups, or
in case that the first resource is an aperiodic resource and the first resource comprises a plurality of resource groups in a plurality of time units, the CSI parameter is determined based on each of the plurality of resource groups.

17. The UE of claim 16, wherein each measurement occasion group comprises all measurement occasions of one or more resources included in the first resource within a measurement window corresponding to each measurement occasion group.

18. The UE of claim 17, wherein a measurement window corresponding to a last measurement occasion group of the plurality of measurement occasion groups is determined based on at least one of:
an offset between a last time unit of a configured measurement window and a CSI reference resource associated with the CSI parameter;
an offset between the last time unit of the configured measurement window and a time unit where the CSI parameter is reported;
a last measurement window of one or more measurement windows determined based on at least one of a periodicity of the first resource or a subframe number (SFN) that is no later than a CSI reference resource associated with the CSI parameter, or
the last measurement window of one or more measurement windows determined based on the at least one of the periodicity of the first resource or the SFN that is no later than a time unit before the time unit where the CSI parameter is reported.

19. A method performed by a base station in a communication system, the method comprising:
transmitting a channel state information (CSI) report configuration, wherein the CSI report configuration comprises information for a first resource; and
receiving CSI parameter on the first resource,
wherein:
in case that the first resource is a periodic resource or a semi-persistent resource, and the first resource corresponds to a plurality of measurement occasion groups, the CSI parameter is based on each of the plurality of measurement occasion groups, or
in case that the first resource is an aperiodic resource and the first resource comprises a plurality of resource groups in a plurality of time units, the CSI parameter is based on each of the plurality of resource groups.

20. A base station in a communication system, the base station comprising:
a transceiver; and
a processor coupled with the transceiver and configured to:
transmit a channel state information (CSI) report configuration, wherein the CSI report configuration comprises information for a first resource; and
receive CSI parameter on the first resource,
wherein:
in case that the first resource is a periodic resource or a semi-persistent resource, and the first resource corresponds to a plurality of measurement occasion groups, the CSI parameter is based on each of the plurality of measurement occasion groups, or
in case that the first resource is an aperiodic resource and the first resource comprises a plurality of resource groups in a plurality of time units, the CSI parameter is based on each of the plurality of resource groups.
